(19) United States
(12) Patent Application Publication
(10) Pub. No.: US 2026/0333233 A1
(43) Pub. Date: Oct. 22, 2026

(54) ON-DEMAND COMMON SIGNALS

(71) Applicant: Fraunhofer-Gesellschaft zur Förderung der angewandten Forschung e.V., München (DE)

(72) Inventors: Gustavo Wagner OLIVEIRA DA COSTA, Erlangen (DE); Julian POPP, Erlangen (DE); Geordie GEORGE, Erlangen (DE); Elke ROTH-MANDUTZ, Erlangen (DE); Martin LEYH, Erlangen (DE); Nazanin VATANIAN, Erlangen (DE)

(73) Assignee: Fraunhofer-Gesellschaft zur Förderung der angewandten Forschung e.V., München (DE)

(21) Appl. No.: 19/701,563

(22) Filed: Jun. 8, 2026

Related U.S. Application Data
(63) Continuation of application No. PCT/EP2024/068200, filed on Jun. 27, 2024.

(30) Foreign Application Priority Data
Dec. 8, 2023 (EP) 23215317.1

(51) Int. Cl. H04W 52/02; H04W 16/28; H04W 56/00; H04W 92/18

(52) U.S. Cl. CPC H04W 52/0235; H04W 16/28; H04W 56/0015; H04W 92/18

(57) ABSTRACT

Embodiment provide a base station for a wireless communication network, wherein the base station is configured to serve a cell of the wireless communication network, wherein the base station is configured to transmit access information enabling one or more UEs to access the cell, wherein the base station is configured, in an energy saving mode of operation, to transmit the access information by transmitting
a first part of the access information, and
a trigger information enabling a UE to trigger a transmission of a second part of the access information.

### CROSS-REFERENCE TO RELATED APPLICATIONS

This application is a continuation of copending International Application No. PCT/EP2024/068200, filed Jun. 27, 2024, which is incorporated herein by reference in its entirety, and additionally claims priority from European Applications Nos. 23215317.1, filed Dec. 8, 2023, which is also incorporated herein by reference in its entirety.

Embodiments of the present application relate to the field of wireless communication, and more specifically, to network energy saving. Some embodiments relate to on-demand common signals.

### BACKGROUND OF THE INVENTION

FIG. 1 is a schematic representation of an example of a terrestrial wireless network 100 including, as is shown in FIG. 1A, a core network 102 and one or more radio access networks (RANs) RAN1, RAN2, . . . RANN. FIG. 1B is a schematic representation of an example of a radio access network RANn that may include one or more base stations (BSs) gNB1 to gNB5, each serving a specific area surrounding the base station schematically represented by respective cells 1061 to 1065. The base stations are provided to serve users within a cell. The term base station, BS, refers to a next generation node B (gNB) in 5G networks, an evolved node B (eNB) in UMTS/LTE/LTE-A/LTE-A Pro, or just a BS in other mobile communication standards. A user may be a stationary device or a mobile device. The wireless communication system may also be accessed by mobile or stationary Internet of Things (IoT) devices which connect to a base station or to a user. The mobile devices or the IoT devices may include physical devices, ground based vehicles, such as robots or cars, aerial vehicles, such as manned or unmanned aerial vehicles (UAVs), the latter also referred to as drones, buildings and other items or devices having embedded therein electronics, software, sensors, actuators, or the like as well as network connectivity that enables these devices to collect and exchange data across an existing network infrastructure. FIG. 1B shows an exemplary view of five cells, however, the RANn may include more or less such cells, and RANn may also include only one base station. FIG. 1B shows two users UE1 and UE2, also referred to as user equipment, UE, that are in cell 1062 and that are served by base station gNB2. Another user UE3 is shown in cell 1064 which is served by base station gNB4. The arrows 1081, 1082 and 1083 schematically represent uplink/downlink connections for transmitting data from a user UE1, UE2 and UE3 to the base stations gNB2, gNB4 or for transmitting data from the base stations gNB2, gNB4 to the users UE1, UE2, UE3. Further, FIG. 1B shows two IoT devices 1101 and 1102 in cell 1064, which may be stationary or mobile devices. The IoT device 1101 accesses the wireless communication system via the base station gNB4 to receive and transmit data as schematically represented by arrow 1121. The IoT device 1102 accesses the wireless communication system via the user UE3 as is schematically represented by arrow 1122. The respective base station gNB1 to gNB5 may be connected to the core network 102, e.g., via the S1 interface, via respective backhaul links 1141 to 1145, which are schematically represented in FIG. 1B by the arrows pointing to “core”. The core network 102 may be connected to one or more external networks. Further, some or all of the respective base station gNB1 to gNB5 may connected, e.g., via the S1 or X2 interface or the XN interface in NR, with each other via respective backhaul links 1161 to 1165, which are schematically represented in FIG. 1B by the arrows pointing to “gNBs”.

For data transmission a physical resource grid may be used. The physical resource grid may comprise a set of resource elements (REs) to which various physical channels and physical signals are mapped. For example, the physical channels may include the physical downlink, uplink and sidelink shared channels (PDSCH, PUSCH, PSSCH) carrying user specific data, also referred to as downlink, uplink and sidelink payload data, the physical broadcast channel (PBCH) carrying for example a master information block (MIB), the physical downlink shared channel (PDSCH) carrying for example a system information block (SIB), the physical downlink, uplink and sidelink control channels (PDCCH, PUCCH, PSSCH) carrying for example the downlink control information (DCI), the uplink control information (UCI) and the sidelink control information (SCI). For the uplink, the physical channels, or more precisely the transport channels according to 3GPP, may further include the physical random access channel (PRACH or RACH) used by UEs for accessing the network once a UE is synchronized and has obtained the MIB and SIB. The physical signals may comprise reference signals or symbols (RS), synchronization signals and the like. The resource grid may comprise a frame or radio frame having a certain duration in the time domain and having a given bandwidth in the frequency domain. The frame may have a certain number of subframes of a predefined length, e.g., 1 ms. Each subframe may include one or more slots of 12 or 14 orthogonal frequency-division multiplexing (OFDM) symbols depending on the cyclic prefix (CP) length. All OFDM symbols may be used for downlink (DL) or uplink (UL) or only a subset, e.g., when utilizing shortened transmission time intervals (sTTI) or a mini-slot/non-slot-based frame structure comprising just a few OFDM symbols.

The wireless communication system may be any single-tone or multicarrier system using frequency-division multiplexing, like the OFDM system, the orthogonal frequency-division multiple access (OFDMA) system, or any other IFFT-based signal with or without CP, e.g., DFT-s-OFDM. Other waveforms, like non-orthogonal waveforms for multiple access, e.g., filter-bank multicarrier (FBMC), generalized frequency division multiplexing (GFDM) or universal filtered multi carrier (UFMC), may be used. The wireless communication system may operate, e.g., in accordance with the LTE-Advanced pro standard or the NR (5G), New Radio, standard.

The wireless network or communication system depicted in FIG. 1 may by a heterogeneous network having distinct overlaid networks, e.g., a network of macro cells with each macro cell including a macro base station, like base station gNB1 to gNB5, and a network of small cell base stations (not shown in FIG. 1), like femto or pico base stations.

In addition to the above described terrestrial wireless network also non-terrestrial wireless communication networks exist including spaceborne transceivers, like satellites, and/or airborne transceivers, like unmanned aircraft systems. The non-terrestrial wireless communication network or system may operate in a similar way as the terrestrial system described above with reference to FIG. 1, for example in accordance with the LTE-Advanced Pro standard or the NR (5G), new radio, standard.

In mobile communication networks, for example in a network like that described above with reference to FIG. 1, like an LTE or 5G/NR network, there may be UEs that communicate directly with each other over one or more sidelink (SL) channels, e.g., using the PC5 interface. UEs that communicate directly with each other over the sidelink may include vehicles communicating directly with other vehicles (V2V communication), vehicles communicating with other entities of the wireless communication network (V2X communication), for example roadside entities, like traffic lights, traffic signs, or pedestrians. Other UEs may not be vehicular related UEs and may comprise any of the above-mentioned devices. Such devices may also communicate directly with each other (D2D communication) using the SL channels.

When considering two UEs directly communicating with each other over the sidelink, both UEs may be served by the same base station so that the base station may provide sidelink resource allocation configuration or assistance for the UEs. For example, both UEs may be within the coverage area of a base station, like one of the base stations depicted in FIG. 1. This is referred to as an “in-coverage” scenario. Another scenario is referred to as an “out-of-coverage” scenario. It is noted that “out-of-coverage” does not mean that the two UEs are not within one of the cells depicted in FIG. 1, rather, it means that these UEs
may not be connected to a base station, for example, they are not in a radio resource control (RRC) connected state, so that the UEs do not receive from the base station any sidelink resource allocation configuration or assistance, and/or
may be connected to the base station, but, for one or more reasons, the base station may not provide sidelink resource allocation configuration or assistance for the UEs, and/or
may be connected to the base station that may not support NR V2X services, e.g., GSM, UMTS, LTE base stations.

When considering two UEs directly communicating with each other over the sidelink, e.g., using the PC5 interface, one of the UEs may also be connected with a BS, and may relay information from the BS to the other UE via the sidelink interface. The relaying may be performed in the same frequency band (in-band-relay) or another frequency band (out-of-band relay) may be used. In the first case, communication on the Uu and on the sidelink may be decoupled using different time slots as in time division duplex (TDD) systems.

FIG. 2 is a schematic representation of an in-coverage scenario in which two UEs directly communicating with each other are both connected to a base station. The base station gNB has a coverage area that is schematically represented by the circle 200 which, basically, corresponds to the cell schematically represented in FIG. 1. The UEs directly communicating with each other include a first vehicle 202 and a second vehicle 204 both in the coverage area 200 of the base station gNB. Both vehicles 202, 204 are connected to the base station gNB and, in addition, they are connected directly with each other over the PC5 interface. The scheduling and/or interference management of the V2V traffic is assisted by the gNB via control signaling over the Uu interface, which is the radio interface between the base station and the UEs. In other words, the gNB provides SL resource allocation configuration or assistance for the UEs, and the gNB assigns the resources to be used for the V2V communication over the sidelink. This configuration is also referred to as a mode 1 configuration in NR V2X or as a mode 3 configuration in LTE V2X.

FIG. 3 is a schematic representation of an out-of-coverage scenario in which the UEs directly communicating with each other are either not connected to a base station, although they may be physically within a cell of a wireless communication network, or some or all of the UEs directly communicating with each other are to a base station but the base station does not provide for the SL resource allocation configuration or assistance. Three vehicles 206, 208 and 210 are shown directly communicating with each other over a sidelink, e.g., using the PC5 interface. The scheduling and/or interference management of the V2V traffic is based on algorithms implemented between the vehicles. This configuration is also referred to as a mode 2 configuration in NR V2X or as a mode 4 configuration in LTE V2X. As mentioned above, the scenario in FIG. 3 which is the out-of-coverage scenario does not necessarily mean that the respective mode 2 UEs (in NR) or mode 4 UEs (in LTE) are outside of the coverage 200 of a base station, rather, it means that the respective mode 2 UEs (in NR) or mode 4 UEs (in LTE) are not served by a base station, are not connected to the base station of the coverage area, or are connected to the base station but receive no SL resource allocation configuration or assistance from the base station. Thus, there may be situations in which, within the coverage area 200 shown in FIG. 2, in addition to the NR mode 1 or LTE mode 3 UEs 202, 204 also NR mode 2 or LTE mode 4 UEs 206, 208, 210 are present.

Naturally, it is also possible that the first vehicle 202 is covered by the gNB, i.e. connected with Uu to the gNB, wherein the second vehicle 204 is not covered by the gNB and only connected via the PC5 interface to the first vehicle 202, or that the second vehicle is connected via the PC5 interface to the first vehicle 202 but via Uu to another gNB, as will become clear from the discussion of FIGS. 4 and 5.

FIG. 4 is a schematic representation of a scenario in which two UEs directly communicating with each, wherein only one of the two UEs is connected to a base station. The base station gNB has a coverage area that is schematically represented by the circle 200 which, basically, corresponds to the cell schematically represented in FIG. 1. The UEs directly communicating with each other include a first vehicle 202 and a second vehicle 204, wherein only the first vehicle 202 is in the coverage area 200 of the base station gNB. Both vehicles 202, 204 are connected directly with each other over the PC5 interface.

FIG. 5 is a schematic representation of a scenario in which two UEs directly communicating with each, wherein the two UEs are connected to different base stations. The first base station gNB1 has a coverage area that is schematically represented by the first circle 2001, wherein the second station gNB2 has a coverage area that is schematically represented by the second circle 2002. The UEs directly communicating with each other include a first vehicle 202 and a second vehicle 204, wherein the first vehicle 202 is in the coverage area 2001 of the first base station gNB1 and connected to the first base station gNB1 via the Uu interface, wherein the second vehicle 204 is in the coverage area 2002 of the second base station gNB2 and connected to the second base station gNB2 via the Uu interface.

In order for a user equipment (UE) to access a network, the UE needs to obtain information about the network. In 3GPP systems this is called System Information (SI). The network broadcasts SI so that UEs can obtain such information. However, SI broadcasting consumes significant power even when there is no traffic load and SI broadcasting represents also significant overhead. For the sake of reducing energy consumption, carbon footprint and operational expenses there is a great interest in reducing the power consumption of mobile networks.

Therefore, there is the need for improvements or enhancements with respect to the gNB power consumption caused by transmitting system information.

It is noted that the information in the above section is only for enhancing the understanding of the background of the invention and therefore it may contain information that does not form conventional technology and is already known to a person of ordinary skill in the art.

### SUMMARY

An embodiment may have a base station for a wireless communication network, wherein the base station is configured to serve a cell of the wireless communication network, wherein the base station is configured to transmit access information enabling one or more user equipments to access the cell, wherein the base station is configured, in an energy saving mode of operation, to transmit the access information by transmitting a first part of the access information, and a trigger information enabling a user equipment of the one or more user equipments to trigger a transmission of a second part of the access information, wherein the base station is configured to serve a plurality of cells or bands, wherein the base station is configured to transmit the first part of the access information and the trigger information on a first cell or band, wherein the base station is configured to receive a trigger signal and to transmit the second part of the access information in response to the trigger signal on a second cell or band, different from the first cell or band.

Another embodiment may have a user equipment, UE, for a wireless communication network, wherein the user equipment is configured to access a cell that is in an energy saving mode of operation and that is transmitting in the energy saving mode of operation only a first part of access information required by the user equipment for accessing the cell, wherein the user equipment is configured to access the cell by at least one out of receiving the first part of the access information, receiving a trigger information enabling the user equipment to trigger a transmission of a second part of the access information, and transmitting a trigger signal based on the trigger information, wherein the user equipment is configured to receive the first part of the access information and the trigger information on a first cell or band, wherein the user equipment is configured to transmit the trigger signal and to receive the second part of the access information on a second cell or band, different from the first cell or band.

According to another embodiment, a method for operating a base station for a wireless communication network may have the steps of: serving a cell of the wireless communication network, transmitting access information enabling one or more user equipments to access the cell, wherein in an energy saving mode of operation the access information is transmitted by transmitting a first part of the access information, and a trigger information enabling a user equipment of the one or more user equipments to trigger a transmission of a second part of the access information, wherein serving includes serving a plurality of cells or bands, wherein the first part of the access information and the trigger information are transmitted on a first cell or band, wherein the method includes receiving a trigger signal, wherein the second part of the access information is transmitted in response to the trigger signal on a second cell or band, different from the first cell or band.

According to another embodiment, a method for operating a user equipment, UE, for a wireless communication network may have the steps of: accessing a cell that is in an energy saving mode of operation and that is transmitting in the energy saving mode of operation only a first part of access information required by the user equipment for accessing the cell, wherein accessing the cell includes receiving the first part of the access information, receiving a trigger information enabling the user equipment to trigger a transmission of a second part of the access information, and transmitting a trigger signal based on the trigger information, wherein the first part of the access information and the trigger information are received on a first cell or band, wherein the trigger signal is transmitted and the second part of the access information are received on a second cell or band, different from the first cell or band.

Another embodiment may have a non-transitory digital storage medium having a computer program stored thereon to perform any of the inventive methods when said computer program is run by a computer.

### BRIEF DESCRIPTION OF THE DRAWINGS

Embodiments of the present invention will be detailed subsequently referring to the appended drawings, in which:

FIG. 1A is a schematic representation of an example of a terrestrial wireless network;

FIG. 1B is a schematic representation of an example of a radio access network RANn that may include one or more base stations;

FIG. 2 is a schematic representation of an in-coverage scenario in which UEs directly communicating with each other are connected to a base station;

FIG. 3 is a schematic representation of an out-of-coverage scenario in which UEs directly communicating with each other receive no SL resource allocation configuration or assistance from a base station;

FIG. 4 is a schematic representation of a partial out-of-coverage scenario in which some of the UEs directly communicating with each other receive no SL resource allocation configuration or assistance from a base station;

FIG. 5 is a schematic representation of an in-coverage scenario in which UEs directly communicating with each other are connected to different base stations;

FIG. 6 is a schematic representation of a wireless communication system comprising a transceiver, like a base station or a relay, and a plurality of communication devices, like UEs, according to an embodiment;

FIG. 7 is a schematic representation of a transmission of initial access information by transmitting, in an always on step, a first part of the initial access information and by transmitting, in an on-demand step, a second part of the initial access information;

FIG. 8 is a schematic representation of a transmission of initial access information by transmitting, in an always on step, a first part of the initial access information, by transmitting, in an additional step, a trigger information allowing a UE to trigger a transmission of a second part of the initial access information, and by transmitting, in an on-demand step, a second part of the initial access information in response to a reception of a trigger signal;

FIG. 9 is a schematic representation of a transmission of initial access information by transmitting, in an always on step, a first part of the initial access information, by transmitting, in an additional step, a trigger information allowing a UE to trigger a transmission of a second part of the initial access information, and by transmitting, in an on-demand step, a second part of the initial access information in response to a reception of a trigger signal;

FIG. 10 is a schematic illustration of a multiplexing pattern of access information and trigger information;

FIG. 11 is a schematic illustration of a multiplexing pattern of access information and trigger information;

FIG. 12 is a schematic illustration of a multiplexing pattern of access information and trigger information;

FIG. 13 is a schematic illustration of a multiplexing pattern of access information and trigger information;

FIG. 14 is a schematic representation of a transmission of initial access information by transmitting, in an always on step, a first part of the initial access information, by transmitting, in an additional step, a trigger information allowing a UE to trigger a transmission of a second part of the initial access information, and by transmitting, in an on-demand step, a second part of the initial access information in response to a reception of a trigger signal;

FIG. 15 is a schematic representation of a transmission of initial access information by transmitting, in an always on step, a first part of the initial access information, by transmitting, in an additional step that is performed in parallel to the always on step, a trigger information allowing a UE to trigger a transmission of a second part of the initial access information, and by transmitting, in an on-demand step, a second part of the initial access information in response to a reception of a trigger signal;

FIG. 16 is a schematic representation of a transmission initial access information by transmitting, in an additional step, a trigger information allowing a UE to trigger a transmission of the initial access information, and by transmitting, in an on-demand step, the initial access information in response to a reception of a trigger signal;

FIG. 17 is a schematic representation of a transmission initial access information by transmitting, in an always on step, a first part of the initial access information, by transmitting, in an additional step, a trigger information allowing a UE to trigger a transmission of a second part of the initial access information, and by transmitting, in an on-demand step, a second part of the initial access information in response to a reception of a trigger signal;

FIG. 18 is a schematic illustration of a multiplexing pattern of access information and trigger information;

FIG. 19 is a schematic illustration of a multiplexing pattern of access information and trigger information;

FIG. 20 is a schematic illustration of a multiplexing pattern of access information and trigger information;

FIG. 21 is a schematic representation of a transmission of initial access information by transmitting, in an always on step, a first part of the initial access information, by transmitting, in an additional step, a trigger information allowing a UE to trigger a transmission of a second part of the initial access information, by transmitting, in a first on-demand step, a first sub-part of a second part of the initial access information in response to a reception of a first trigger signal, and by transmitting, in a second on-demand step, a second sub-part of the second part of the initial access information in response to a reception of a second trigger signal;

FIG. 22 is a schematic representation of a wireless communication system comprising a base station and a plurality of UEs, where one of the UEs serves as a sidelink relay for relaying signals between the base station and a remote UE;

FIG. 23 is a schematic representation of a wireless communication system comprising two base stations and a plurality of UEs, where some of the UEs serve as sidelink relays for relaying signals between the base stations and remote UEs;

FIG. 24 is a schematic representation of a time pattern for transmission of trigger procedure information; and

FIG. 25 illustrates an example of a computer system on which units or modules as well as the steps of the methods described in accordance with the inventive approach may execute.

### DETAILED DESCRIPTION OF THE INVENTION

Equal or equivalent elements or elements with equal or equivalent functionality are denoted in the following description by equal or equivalent reference numerals.

In the following description, a plurality of details are set forth to provide a more thorough explanation of embodiments of the present invention. However, it will be apparent to one skilled in the art that embodiments of the present invention may be practiced without these specific details. In other instances, well-known structures and devices are shown in block diagram form rather than in detail in order to avoid obscuring embodiments of the present invention. In addition, features of the different embodiments described hereinafter may be combined with each other, unless specifically noted otherwise.

As indicated above, in order for a User Equipment (UE) to access a network, the UE needs to obtain information about the network. In 3GPP systems this is called System Information (SI). The network broadcasts SI so that UEs can obtain such information. However, SI broadcasting consumes significant power even when there is no traffic load and SI broadcasting represents also significant overhead. For the sake of reducing energy consumption, carbon footprint and operational expenses there is a great interest in reducing the power consumption of mobile networks.

The System Information is typically divided into smaller blocks. In 3G/4G/5G such blocks are called System Information Blocks (SIBs). The very first block of system information is referred to as Master Information Block (MIB). In each system some of the SIBs are mandatory and some are optional. But in essence, in 3G and 4G if a SIB is present it is also broadcast. The broadcast can have a schedule where more important messages are sent more often and less important messages are sent less often. This reduces overhead and saves some energy by avoiding that less important SIBs being transmitted more often than needed.

5G NR takes a further step in reducing overhead and minimizing the energy spent on SIB broadcasting: some SIBs can be broadcast on demand. In 5G, as described in [1], the SI is divided into two parts: the Minimum System Information (MSI) and Other SI. The MSI is always present and always broadcast. The MSI is defined as “Minimum SI comprises basic information required for initial access and information for acquiring any other SI.” And it consists of two parts, the MIB and SIB-1, the latter also being referred as Remaining Minimum System Information (RMSI). Other SI are all other SIs which are not part of MSI. The Other SI may be 1) broadcast according to a schedule (e.g., like in 3G/4G), or 2) sent on demand for UEs which are on RRC_IDLE/RRC_INACTIVE as triggered by a random access procedure, or 3) sent via dedicated RRC messages when a UE is on RRC_CONNECTED. In any of the three cases, the information on how to access Other SI is given on MSI as seen in [2]. It should also be noted that it is not to be taken for granted that on-demand transmission of Other SI leads to any energy savings. If there are frequent requests from UEs to send Other SI, it may actually lead to a consumption larger than a broadcast according to a certain schedule.

As explained previously, there is an urgent need for Network Energy Savings (NES). This need leads to further discussion on how to reduce the energy consumption caused by SI broadcasting. [3] identifies some potential directions: SSB on-demand and SIB-1 on-demand. The Synchronization Signal Block (SSB) is a block which includes essential synchronization signals and the MIB. In essence, the conclusions in [3]suggest that if SSB and SIB-1 could be sent only when needed large energy savings would be possible at low traffic loads. However, [3]does not define how that can be done and an actual design of SSB on-demand and/or SIB-1 on-demand needs to address a large number of practical issues.

As an important example of conceptual gap on the state-of-art, the transmission of MSI (MIB/SIB-1) cannot be simply triggered like Other SI. As described above, the information to trigger on-demand Other SI is carried on MSI and MSI would not be present to identify how it can be triggered on-demand. A practical implementation of SSB on-demand and SIB-1 on-demand can only be achieved with a novel more elaborate solution and related procedures.

Below described embodiments solve the problem of how to send SI on-demand such that network energy savings (NES) can be achieved and/or overhead can be reduced.

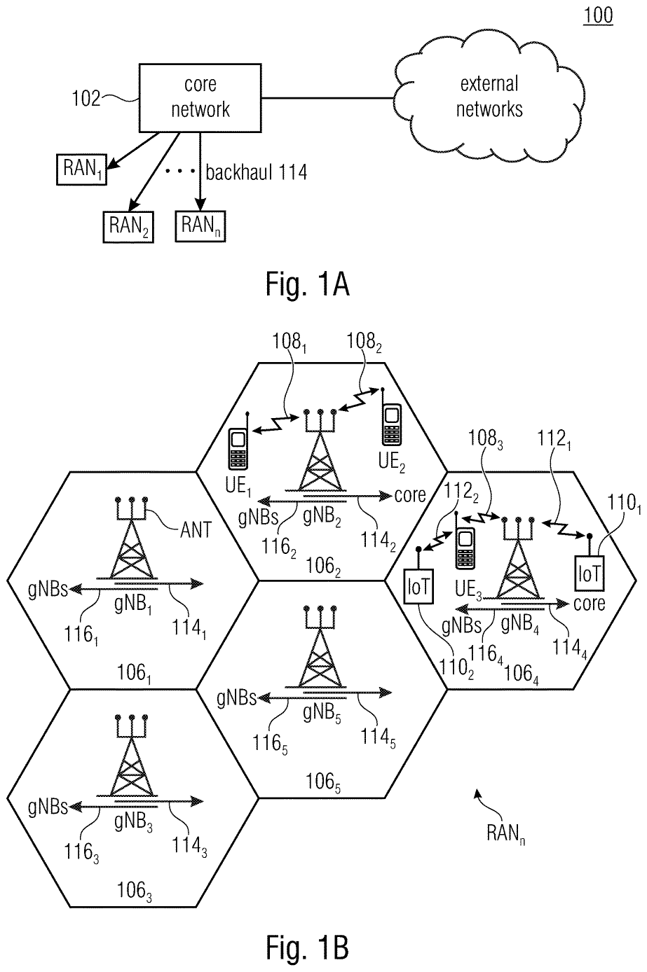

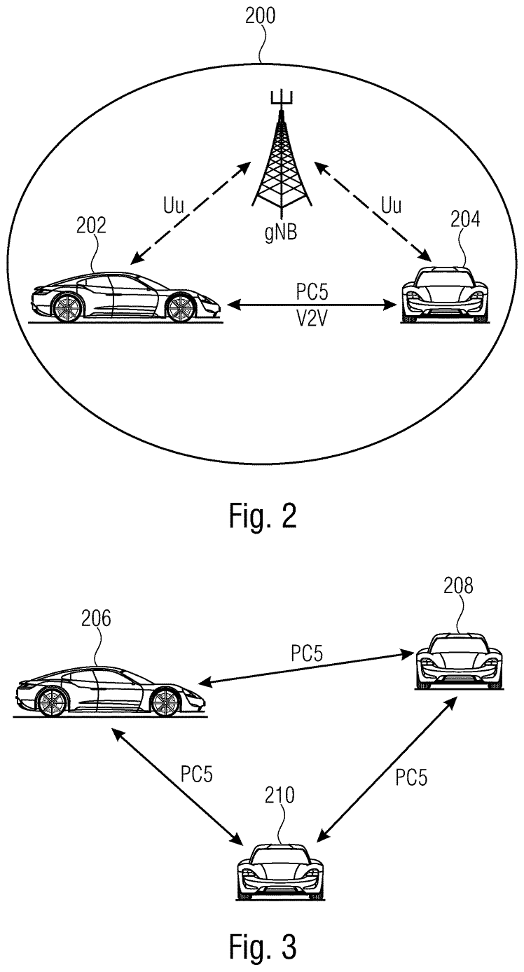

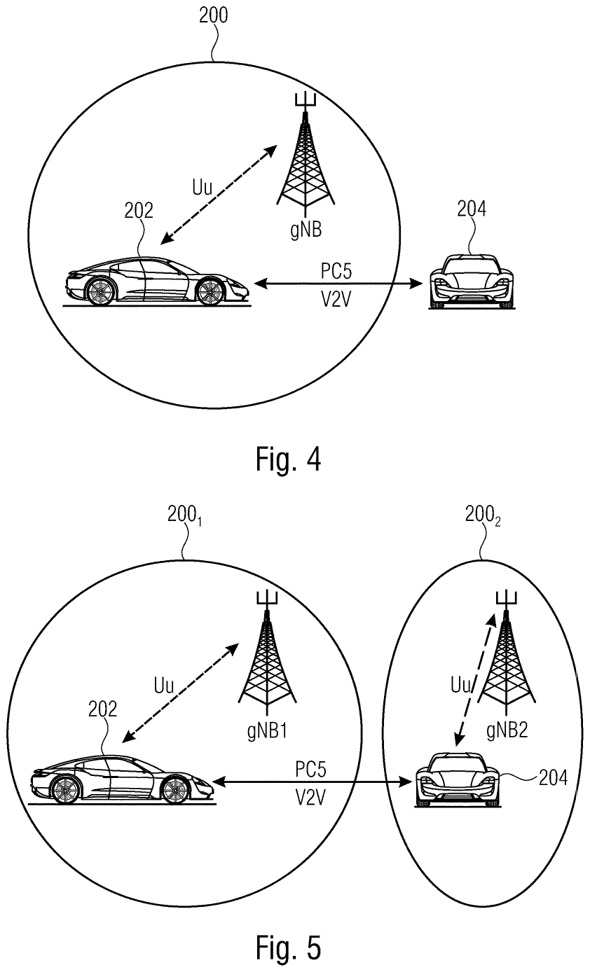

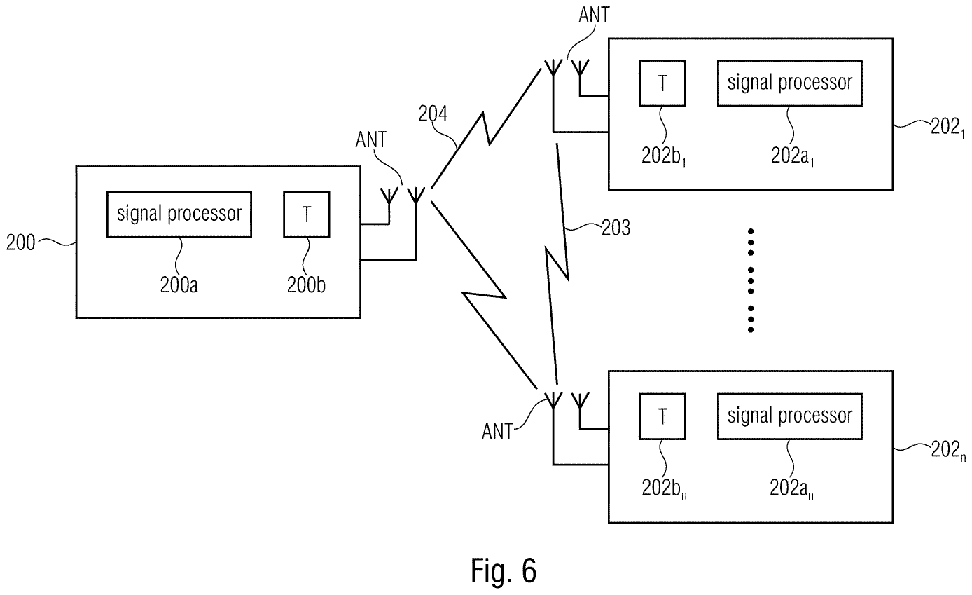

Embodiments of the present invention may be implemented in a wireless communication system or network as depicted in FIGS. 1 to 5 including a transceiver, like a base station, gNB, or relay, and a plurality of communication devices, like user equipment's, UEs. FIG. 6 is a schematic representation of a wireless communication system comprising a transceiver 200, like a base station, and a plurality of communication devices 202₁ to 202ₙ, like UEs. The UEs might communicated directly with each other via a wireless communication link or channel 203, like a radio link (e.g., using the PC5 interface (sidelink)). Further, the transceiver and the UEs 202 might communicate via a wireless communication link or channel 204, like a radio link (e.g., using the uU interface). The transceiver 200 might include one or more antennas ANT or an antenna array having a plurality of antenna elements, a signal processor 200a and a transceiver unit 200b. The UEs 202 might include one or more antennas ANT or an antenna array having a plurality of antennas, a processor 202a₁ to 202aₙ, and a transceiver (e.g., receiver and/or transmitter) unit 202b₁ to 202bₙ. The base station 200 and/or the one or more UEs 202 may operate in accordance with the inventive teachings described herein.

Embodiments provide a base station [e.g., gNB] for a [e.g., 5G/NR] wireless communication network, wherein the base station is configured to serve a cell of the wireless communication network, wherein the base station is configured to transmit [e.g., initial] access information enabling one or more UEs to [e.g., initially] access the cell, wherein the base station is configured, in an energy saving mode of operation, to transmit the access information by transmitting
a first part [e.g., a first proper subset] of the access information, and
a trigger information enabling a UE to trigger a transmission of a second part of the access information.

In embodiments, the base station is configured, in the energy saving mode of operation, to transmit the access information by transmitting
a second part [e.g., a second proper subset] of the access information in response to a reception of a trigger signal [e.g., wake-up signal] [e.g., requesting/triggering a transmission of the second part of the access information].

In embodiments, the first part of the access information and the second part of the access information [e.g., together or in combination] from the access information.

In embodiments, the access information comprises synchronization signals and/or system information.

In embodiments, the first part of the access information includes only a first part of the synchronization signals and/or system information, wherein the second part of the access information includes at least a second part of the synchronization signals and/or system information [e.g., not included in the first part of the access information].

In embodiments, the access information includes at least two out of
a primary synchronization signal,
a secondary synchronization signal,
a master information block, MIB,
a system information block one, SIB-1,
a further system information block [e.g., SIB-2].

For example, the first part of the access information includes at least one out of a primary synchronization signal, a secondary synchronization signal, a master information block, MIB, and a system information block one, SIB-1, wherein the second part of the access information includes the other one out of the primary synchronization signal, the secondary synchronization signal, the master information block, MIB, and the system information block one, SIB-1, which are not included in the first part of the access information. Naturally, it is also possible, that the first part of the access information includes [e.g., (optionally) besides other synchronization signals and/or system information]only a portion of one out of the primary synchronization signal, the secondary synchronization signal, the master information block, MIB, and the system information block one, SIB-1, where the second part of the access information includes at least the other part of the respective synchronization signal or system information.

In embodiments, the base station is configured, in a normal operation mode, to transmit the complete access information [e.g., to transmit the first part of the access information and to [e.g., directly]transmit the second part of the access information [e.g., independent on a reception of the trigger signal].

In embodiments, the first part of the access information comprises an information indicating whether the trigger information is transmitted.

In embodiments, the base station is configured to transmit a first signaling information indicating whether and/or when the trigger information and/or the second part of the access information are transmitted.

In embodiments, the base station is configured to transmit a second signaling information indicating whether and/or when the base station will switch between the energy saving operation mode and a normal operation mode.

In embodiments, the base station is configured, in the energy saving mode of operation, to only receive those random access signals that carry the trigger signal.

In embodiments, the base station is configured to transmit the trigger information [e.g., TP-info] using beamforming in a plurality of beamforming directions.

In embodiments, the trigger signal is a wake-up signal transmitted on the same cell than the access information, wherein the trigger information describes a time and/or frequency resource to be used for transmitting the trigger signal.

In embodiments, the trigger signal is a wake-up signal transmitted on another cell than the access information, wherein the trigger information describes how to access the other cell for transmitting the trigger signal.

In embodiments, the trigger signal is transmitted on a LTE cell, wherein the trigger information describes a frequency of the LTE cell for transmitting the trigger signal.

In embodiments, the trigger signal is transmitted via a sidelink, wherein the trigger information describes a sidelink resource pool for transmitting the trigger signal.

In embodiments, the second part of the access information comprises a system information block one, SIB-1.

In embodiments, the trigger information is transmitted by means of a first downlink control information, wherein the second part of the access information comprises a second downlink control information, wherein the first downlink control information and the second downlink control information are associated with different radio network temporary identifiers, RNTIs.

In embodiments, the first downlink control information is transmitted on control resource set zero, CORESET #0.

In embodiments, the base station is configured to transmit the first part of the access information comprising the system information block one, SIB-1, [e.g., independent of the operation mode,] periodically with a first period, wherein the base station is configured to transmit an additional information, the additional information comprising the trigger information and an information describing the first period of the periodic transmission of the first part of the access information comprising the system information block one, SIB-1, wherein the second part of the access information also comprises a system information block one, SIB-1, wherein the base station is configured to transmit the second part of the access information comprising the system information block one, SIB-1, in response to a reception of the trigger signal, periodically with a second period smaller than the first period.

In embodiments, the base station is configured to transmit an additional information comprising the trigger information and a portion of the system information block one, SIB-1.

In embodiments, the portion of the system information block one, SIB-1, is at least one out of
a first indication indicating whether the cell is barred or not,
a second indication indicating whether certain groups of UEs should consider the cell as barred or not,
a third indication indicating whether IMS emergency calls are supported or not,
a hashed version of a public land mobile network, PLMN,
an information describing at least one out of SSB position, a SSB periodicity, a TDD pattern, a time alignment and an offset.

In embodiments, the base station is configured to transmit the first downlink control information multiplexed with a synchronization signal block [e.g., PSS and/or SSS].

In embodiments, the base station is configured to transmit the first downlink control information and the synchronization signal block in the same slot.

In embodiments, the base station is configured to transmit the first downlink control information and the synchronization signal block on different symbols of the same slot.

In embodiments, the first part of the access information comprises a primary synchronization signal block and a secondary synchronization signal block, wherein the second part of the access information comprises a master information block, MIB, and a system information block one, SIB-1, wherein the trigger information is a tertiary synchronization signal indicating that the second part of the access information is transmitted in response to the trigger signal.

In embodiments, the first part of the access information comprises a master information block, MIB, wherein the second part of the access information comprises a system information block one, SIB-1, wherein the trigger information is included in the master information block, MIB.

In embodiments, the trigger information is included in the master information block, MIB, by means of a K-ssb value.

In embodiments, the trigger information is included in the master information block, MIB, as separate indication [e.g., using one spare bit on the MIB].

In embodiments, the master information block, MIB, is an extended master information block comprising at least one bit indicating that an extension of the master information block is transmitted.

In embodiments, the trigger information is included in the master information block, MIB, by means of a direct indication that the transmission of the second part of the access information is to be triggered by the trigger signal.

In embodiments, the trigger signal is a wake-up signal.

In embodiments, the first part of the access information comprises a master information block, MIB, wherein the second part of the access information comprises a system information block one, SIB-1, wherein the base station is configured to transmit an additional information comprising a partial system information block one [e.g., SIB-0]comprising only a part of the system information block one, wherein the partial system information block one [e.g., SIB-0]comprises the trigger information.

In embodiments, the partial system information block one [e.g., SIB-0] is transmitted via a physical downlink shared channel, PDSCH.

In embodiments, the base station is configured to transmit the partial system information block one using beamforming in a plurality of beamforming directions.

In embodiments, the base station is configured to transmit the partial system information block one multiplexed with a synchronization signal block [e.g., PSS and/or SSS].

In embodiments, the trigger signal is a first trigger signal, wherein the base station is configured to transmit the second part of the access information divided into two sub-parts, wherein the base station is configured to transmit the a first sub-part of the second part of the access information in response to a reception of the first trigger signal, wherein the base station is configured to transmit the second sub-part of the second part of the access information in response to a reception of a second trigger signal.

In embodiments, the base station is configured to receive the trigger signal via sidelink relaying UE.

In embodiments, the base station is configured to transmit the trigger information via a sidelink relaying UE.

In embodiments, the base station is configured to control a UE of the cell to transmit the trigger information in case that the base station switches to an energy saving operation mode.

In embodiments, the base station is configured to transmit, prior to the transmission of the first part of access information and/or to the transmission of the trigger information, an early information on cell-barring and/or the availability of system information block one, SIB-1, on demand.

In embodiments, the base station is configured to transmit the trigger information via direct signaling to a UE.

In embodiments, the base station is configured to transmit the trigger information via direct singling before switching into an energy saving mode of operation.

In embodiments, the base station is configured to switch into the energy saving mode of operation in dependence on an operation condition.

In embodiments, the operation condition is at least one out of
a load of the base station,
a radio resource control state of UEs connected to the base station,
a reception of a control signal [e.g., from a primary cell]controlling the base station to the energy saving mode of operation.

In embodiments, the trigger signal is one out of
a wake-up signal,
a cell wake-up signal on the same band/cell,
a cell wake-up signal on the another band/cell,
a cell Wake-up signal on LTE cell,
a cell Wake-up signal via sidelink relay,
a trigger message via core.

For example, the trigger signal can be a wake-up signal transmitted on the same cell than the access information, wherein the trigger information describes a time and/or frequency resource to be used for transmitting the trigger signal.

For example, the trigger signal is a wake-up signal transmitted on another cell than the access information, wherein the trigger information describes how to access the other cell for transmitting the trigger signal.

In embodiments, the base station is configured to switch between a normal operation mode and the energy saving operation mode in dependence on at least one out of
scheduling,
Xn signaling,
O&M,
core signaling.

In embodiments, the trigger information describes one or more out of
a [e.g., time and/or frequency]position of a synchronization signal [e.g., SSB PositionsInBurst],
at least a part of an uplink configuration,
at least a part of a random access channel configuration,
at least a part of a power configuration,
at least a part of a time and/or frequency division duplex configuration,
at least a part of a system information configuration [e.g., allowing the UE to monitor a transmission of system information [e.g., MIB/SIB-1]].

In embodiments, the base station is configured to receive the trigger signal on a first cell or band, wherein the base station is configured to transmit at least one out of
the first part of the access information,
the trigger information,
the second part of the access information,
   on a second cell or band, different from the first band or cell.

In embodiments, the base station is configured to serve a plurality of cells or bands, wherein the base station is configured to transmit the first part of the access information and the trigger information on a first cell or band, wherein the base station is configured to receive the trigger signal and to transmit the second part of the access information in response to the trigger signal on a second cell or band, different from the first cell or band.

In embodiments, the trigger information enables the UE to trigger a transmission of the second part of the access information in at least one second cell.

In embodiments, the trigger information describes, for each of the at least one second cell, one or more out of
an identity of the second cell [e.g., physical cell identity, PCI],
a frequency or channel of the second cell [e.g., absolute radio frequency channel number, ARFCN],
a [e.g., time and/or frequency]position of a synchronization signal [e.g., SSB PositionsInBurst],
at least a part of an uplink configuration,
at least a part of a random access channel configuration,
at least a part of a power configuration,
at least a part of a time and/or frequency division duplex configuration,
at least a part of a system information configuration [e.g., allowing the UE to monitor a transmission of system information [e.g., MIB/SIB-1]].

In embodiments, the base station is configured to transmit the trigger information by means of a container.

In embodiments, the base station is configured to transmit the trigger information together with system information of the first cell or band.

In embodiments, the base station is configured to receive the trigger signal on the same band or cell then the first part of the access information, the trigger information and/or the second part of the access information are transmitted.

In embodiments, the base station is configured to transmit the first part of the access information with a first periodicity and to transmit the trigger information with a second periodicity, wherein a period of the first periodicity and a period of the second periodicity are different.

In embodiments, a period of the second periodicity is larger than a period of the first periodicity.

In embodiments, the trigger information has a small repetition period within the trigger information periodicity [e.g. the 20 ms repetition period within the 320 ms period].

In embodiments, the base station is configured to transmit the trigger information repeatedly according to a first pattern.

In embodiments, the base station is configured to transmit the first access information repeatedly according to a second pattern.

For example, the repetitions follow a pre-defined pattern. For example, the first pattern and the second pattern are different.

In embodiments, the base station is configured to transmit the trigger information only on frames containing synchronization blocks.

Embodiments provide a base station [e.g., gNB] for a [e.g., 5G/NR]wireless communication network, wherein the base station is configured to serve a cell of the wireless communication network, wherein the base station is configured to transmit [e.g., initial] access information enabling one or more UEs to initially access the cell, wherein the base station is configured, in an energy saving mode of operation, to transmit a trigger information enabling a UE to trigger a transmission of the access information and to transmit the access information in response to a reception of a trigger message.

Embodiments provide a sidelink relaying UE for a [e.g., 5G/NR]wireless communication network, wherein the sidelink relaying UE is configured to relay signals between a base station of the wireless communication network and a remote UE, wherein the signals include one or more out of
a transmission of a part of access information from the base station to the remote UE,
a transmission of a trigger signal [e.g., wake-up signal]from the remote UE to the base station,
a transmission of a trigger information from a base station to the remote UE.

In embodiments, the sidelink relaying UE acts as a relay due to
UE capability,
pre-configuration [e.g., firmware configuration, uSIM card properties],
configuration message [e.g., RRC configuration], or
a higher layer configuration [e.g., sidelink application].

In embodiments, the user equipment is configured to [e.g., initially] access a cell that is in an energy saving mode of operation and that is transmitting in the energy saving mode of operation only a first part of access information required by the UE for accessing the cell, wherein the user equipment is configured to access the cell by at least one out of
receiving the first part of the access information,
receiving a trigger information enabling the UE to trigger a transmission of a second part of the access information, and
transmitting a trigger signal [e.g., wake-up signal]based on the trigger information.

In embodiments, the user equipment is configured to access the cell by
receiving the second part of the access information [e.g., in response to a transmission of the trigger message].

In embodiments, the first part of the access information and the second part of the access information [e.g., together or in combination]from the access information.

In embodiments, the access information comprises synchronization signals and/or system information.

In embodiments, the first part of the access information includes only a first part of the synchronization signals and/or system information, wherein the second part of the access information includes at least a second part of the synchronization signals and/or system information [e.g., not included in the first part of the access information].

In embodiments, the access information includes at least two out of
a primary synchronization signal,
a secondary synchronization signal,
a master information block, MIB,
a system information block one, SIB-1,
a further system information block [e.g., SIB-2].

In embodiments, the first part of the access information comprises an information indicating whether the trigger information is transmitted.

In embodiments, the user equipment is configured to receive a first signaling information indicating whether and/or when the trigger information and/or the second part of the access information are transmitted.

In embodiments, the user equipment is configured to receive a second signaling information indicating whether and/or when the base station will switch between the energy saving operation mode and a normal operation mode.

In embodiments, the user equipment is configured to receive the trigger information by receiving one out of a plurality of different beams by means of which the trigger information is transmitted.

In embodiments, the trigger signal is wake-up signal transmitted on the same cell than the access information, wherein the trigger information describes a time and/or frequency resource to be used for transmitting the trigger signal.

In embodiments, the trigger signal is wake-up signal transmitted on another cell than the access information, wherein the trigger information describes how to access the other cell for transmitting the trigger signal.

In embodiments, the trigger signal is transmitted on a LTE cell, wherein the trigger information describes a frequency of the LTE cell for transmitting the trigger signal.

In embodiments, the trigger signal is transmitted via a sidelink, wherein the trigger information describes a sidelink resource pool for transmitting the trigger signal.

In embodiments, the second part of the access information comprises at least a part of a system information block one, SIB-1.

In embodiments, the trigger information is transmitted by means of a first downlink control information, wherein the second part of the access information comprises a second downlink control information, wherein the first downlink control information and the second downlink control information are associated with different radio network temporary identifiers, RNTIs.

In embodiments, the first downlink control information is transmitted on control resource set zero, CORESET #0.

In embodiments, the first part of the access information comprising the system information block one, SIB-1, is transmitted periodically with a first period, wherein the user equipment is configured to receive an additional information comprising the trigger information and an information describing the first period of the periodic transmission of the first part of the access information comprising the system information block one, SIB-1, wherein the second part of the access information also comprises a system information block one, SIB-1, wherein the second part of the access information comprising the system information block one, SIB-1, is transmitted in response to the trigger signal, periodically with a second period smaller than the first period.

In embodiments, the user equipment is configured to receive an additional information comprising the trigger information and a portion of the system information block one, SIB-1.

In embodiments, the portion of the system information block one, SIB-1, is at least one out of
a first indication indicating whether the cell is barred or not,
a second indication indicating whether certain groups of UEs should consider the cell as barred or not,
a third indication indicating whether IMS emergency calls are supported or not,
a hashed version of a public land mobile network, PLMN,
an information describing at least one out of SSB position, a SSB periodicity, a TDD pattern, a time alignment and an offset.

In embodiments, the first downlink control information is multiplexed with a synchronization signal block [e.g., PSS and/or SSS].

In embodiments, the first downlink control information and the synchronization signal block are transmitted in the same slot.

In embodiments, the first downlink control information and the synchronization signal block are transmitted on different symbols of the same slot.

In embodiments, the first part of the access information comprises a primary synchronization signal block and a secondary synchronization signal block, wherein the second part of the access information comprises a master information block, MIB, and a system information block one, SIB-1, wherein the trigger information is a tertiary synchronization signal indicating that the second part of the access information is transmitted in response to the trigger signal.

In embodiments, the first part of the access information comprises a master information block, MIB, wherein the second part of the access information comprises a system information block one, SIB-1, wherein the trigger information is included in the master information block, MIB.

In embodiments, the trigger information is included in the master information block, MIB, by means of a K-ssb value.

In embodiments, the trigger information is included in the master information block, MIB, as separate indication [e.g., using one spare bit on the MIB].

In embodiments, the master information block, MIB, is an extended master information block comprising at least one bit indicating that an extension of the master information block is transmitted.

In embodiments, the trigger information is included in the master information block, MIB, by means of a direct indication that the transmission of the second part of the access information is to be triggered by the trigger signal.

In embodiments, the trigger signal is a wake-up signal.

In embodiments, the first part of the access information comprises a master information block, MIB, wherein the second part of the access information comprises a system information block one, SIB-1, wherein user equipment is configured to receive an additional information comprising a partial system information block one [e.g., SIB-0]comprising only a part of the system information block one, wherein the partial system information block one [e.g., SIB-0]comprises the trigger information.

In embodiments, the partial system information block one [e.g., SIB-0] is transmitted via a physical downlink shared channel, PDSCH.

In embodiments, the user equipment is configured to receive the partial system information block one by receiving a beam of a plurality of different beams using which the partial system information block one is transmitted.

In embodiments, the partial system information block one is multiplexed with a synchronization signal block [e.g., PSS and/or SSS].

In embodiments, the trigger signal is a first trigger signal, wherein the second part of the access information is transmitted divided into two sub-parts, wherein the user equipment is configured to transmit the first trigger signal in order to trigger a transmission of a first sub-part of the second part of the access information, wherein user equipment is configured to transmit the second trigger signal in order to trigger a transmission of a second sub-part of the second part of the access information in response to a reception of a second trigger signal.

In embodiments, the user equipment is configured to transmit the trigger signal via sidelink relaying UE.

In embodiments, the user equipment is configured to receive the trigger information via a sidelink relaying UE.

In embodiments, the user equipment is configured to receive, prior to the first part of access information and/or to the trigger information, an early information on cell-barring and/or the availability of system information block one, SIB-1, on demand.

In embodiments, the user equipment is configured to receive the trigger information via direct signaling.

In embodiments, the trigger signal is one out of
a wake-up signal,
a cell wake-up signal on the same band/cell,
a cell wake-up signal on the another band/cell,
a cell Wake-up signal on LTE cell,
a cell Wake-up signal via sidelink relay,
a trigger message via core.

For example, the trigger signal can be a wake-up signal transmitted on the same cell than the access information, wherein the trigger information describes a time and/or frequency resource to be used for transmitting the trigger signal.

For example, the trigger signal is a wake-up signal transmitted on another cell than the access information, wherein the trigger information describes how to access the other cell for transmitting the trigger signal.

In embodiments, the trigger information describes one or more out of
a [e.g., time and/or frequency]position of a synchronization signal [e.g., SSB PositionsInBurst],
at least a part of an uplink configuration,
at least a part of a random access channel configuration,
at least a part of a power configuration,
at least a part of a time and/or frequency division duplex configuration,
at least a part of a system information configuration [e.g., allowing the UE to monitor a transmission of system information [e.g., MIB/SIB-1]].

In embodiments, the user equipment is configured to transmit the trigger signal on a first cell or band, wherein the user equipment is configured to receive at least one out of
the first part of the access information,
the trigger information,
the second part of the access information, on a second cell or band, different from the first band or cell.

In embodiments, the user equipment is configured to receive the first part of the access information and the trigger information on a first cell or band, wherein the user equipment is configured to transmit the trigger signal and to receive the second part of the access information on a second cell or band, different from the first cell or band.

In embodiments, the trigger information enables the UE to trigger a transmission of the second part of the access information in at least one second cell.

In embodiments, the trigger information describes, for each of the at least one second cell, one or more out of
an identity of the second cell [e.g., physical cell identity, PCI],
a frequency or channel of the second cell [e.g., absolute radio frequency channel number, ARFCN],
a [e.g., time and/or frequency]position of a synchronization signal [e.g., SSB PositionsInBurst],
at least a part of an uplink configuration,
at least a part of a random access channel configuration,
at least a part of a power configuration,
at least a part of a time and/or frequency division duplex configuration,
at least a part of a system information configuration [e.g., allowing the UE to monitor a transmission of system information [e.g., MIB/SIB-1]].

In embodiments, the user equipment is configured to receive the trigger information by means of a container.

In embodiments, the user equipment is configured to receive the trigger information together with system information of the first cell or band.

In embodiments, the user equipment is configured to transmit the trigger signal on the same band or cell then the first part of the access information, the trigger information and/or the second part of the access information are received.

In embodiments, the user equipment is configured to receive the first part of the access information based on a first periodicity and to receive the trigger information based on a second periodicity, wherein a period of the first periodicity and a period of the second periodicity are different.

In embodiments, a period of the second periodicity is larger than a period of the first periodicity.

In embodiments, the trigger information has a small repetition period within the trigger information periodicity [e.g. the 20 ms repetition period within the 320 ms period].

In embodiments, the trigger information is transmitted repeatedly according to a first pattern.

In embodiments, the first access information is transmitted repeatedly according to a second pattern.

For example, the repetitions follow a pre-defined pattern. For example, the first pattern and the second pattern are different.

In embodiments, the user equipment is configured to receive the trigger information only on frames containing synchronization blocks.

Embodiments provide an user equipment [e.g., gNB] for a [e.g., 5G/NR]wireless communication network, wherein the user equipment is configured to [e.g., initially] access a cell that is in an energy saving mode of operation and that is transmitting in the energy saving mode of operation only access information required by the UE for accessing the cell only in response to a reception of a trigger signal, wherein the user equipment is configured to access the cell by
receiving a trigger information enabling the UE to trigger a transmission of a second part of the access information, and
transmitting a trigger message based on the trigger information.

Embodiments provide a method for operating a base station [e.g., gNB] for a [e.g., 5G/NR]wireless communication network. The method comprises a step of serving a cell of the wireless communication network. The method comprises a step of transmitting [e.g., initial] access information enabling one or more UEs to [e.g., initially] access the cell, wherein in an energy saving mode of operation the access information is transmitted by transmitting
a first part [e.g., a first proper subset] of the access information, and
a trigger information enabling a UE to trigger a transmission of a second part of the access information.

Embodiments provide a method for operating a base station [e.g., gNB] for a [e.g., 5G/NR] wireless communication network. The method comprises a step of serving a cell of the wireless communication network. The method comprises a step of transmitting [e.g., initial] access information enabling one or more UEs to [e.g., initially] access the cell, wherein in an energy saving mode of operation the access information is transmitted only in response to a reception of a trigger signal triggering the transmission of the access information.

Embodiments provide a method for operating a sidelink relaying UE fora [e.g., 5G/NR] wireless communication network. The method comprises a step of relaying signals between a base station of the wireless communication network and a remote UE, wherein the signals include one or more out of
a transmission of a part of access information from the base station to the remote UE,
a transmission of a trigger signal from the remote UE to the base station,
a transmission of a trigger information from a base station to the remote UE.

Embodiments provide a method for operating a user equipment, UE, for a [e.g., 5G/NR]wireless communication network. The method comprises a step of accessing a cell that is in an energy saving mode of operation and that is transmitting in the energy saving mode of operation only a first part of access information required by the UE for accessing the cell, wherein accessing the cell comprises
receiving the first part of the access information,
receiving a trigger information enabling the UE to trigger a transmission of a second part of the access information, and
transmitting a trigger message based on the trigger information.

Embodiments provide a method for operating a user equipment, UE, for a [e.g., 5G/NR] wireless communication network. The method comprises a step of accessing a cell that is in an energy saving mode of operation and that is transmitting in the energy saving mode of operation only access information required by the UE for accessing the cell only in response to a reception of a trigger signal, wherein accessing the cell comprises
receiving a trigger information enabling the UE to trigger a transmission of a second part of the access information, and
transmitting a trigger message based on the trigger information.

In embodiments, to obtain essential system information on a dynamic basis, the signals and information blocks which are broadcast by a gNB in order to enable the initial access of UEs are considered as a sequence of steps. In embodiments, this sequence of steps may be broken down into two parts:
A first part of the sequence of steps which is always performed (e.g., broadcast by the gNB, decoded by the UE) regardless of operation mode, and
a second part of the sequence of steps being potentially performed on-demand, i.e. the downlink part is broadcast on-demand and the uplink part is available for reception on-demand.

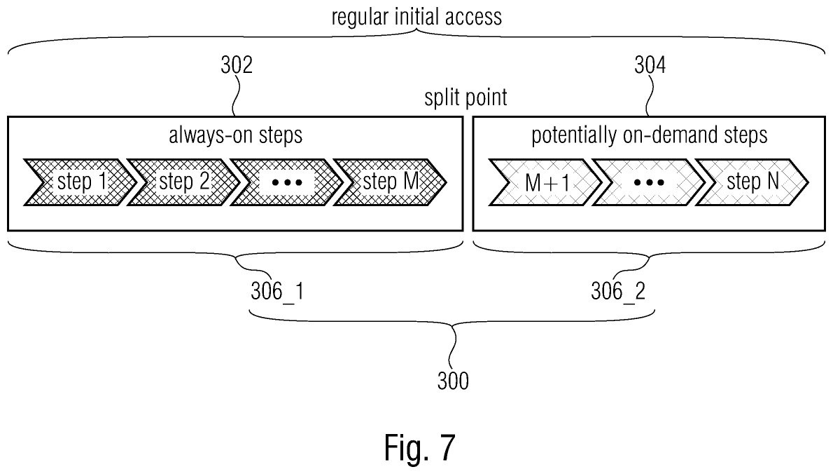

The concept is illustrated in FIG. 7, where it is shown that the regular initial access may be split into two sequence of actions. Specifically, FIG. 7 is a schematic representation of a transmission of initial access information 300 by transmitting, e.g., as always on steps 302 (e.g., step 1 to step M, where M is a natural number greater than or equal to one), a first part 306_1 of the initial access information 300 and by transmitting, e.g., as on-demand steps 304 (e.g., steps M+1 to step N, where N is a natural number greater than M), a second part 306_2 of the initial access information 300. Thereby, the first part 306_1 of the initial access information 300 can be transmitted always (e.g., regularly/periodically (e.g., according to a schedule)), where the second part 306_2 of the initial access information 300 can be transmitted on demand only, e.g., in response to a reception of a trigger signal. As shown in FIG. 7, the regular initial access gets split into two sequence of steps.

In embodiments, depending on the network state or further conditions, the second part of the sequence of steps, namely on-demand steps, is performed or not. This may include the control to broadcast downlink signals or not and to perform uplink reception or not. When the on-demand steps are not performed, the gNB may broadcast additional steps. Alternatively, these additional steps may be always broadcast regardless of network state. The additional steps include at least information on how the UE can trigger switching the network state so that the on-demand steps are performed, but it may also contain more information. When the on-demand steps are being performed, the additional steps may be not performed anymore or they can still be performed.

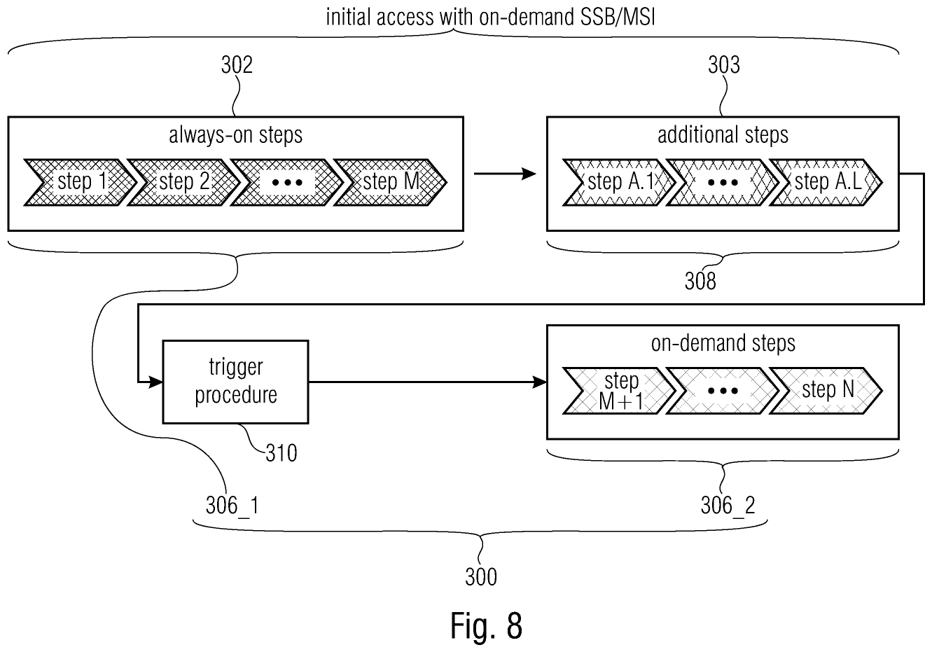

FIG. 8 shows that in order to broadcast the second sequence of steps on-demand two new elements can be introduced: additional steps 303 and a trigger procedure 310. Specifically, FIG. 8 is a schematic representation of a transmission of initial access information 300 by transmitting, e.g., in an always on step 302 (e.g., step 1 to step M, where M is a natural number greater than or equal to one), a first part 306_1 of the initial access information 300, by transmitting, in an additional step 303 (e.g., step A.1 to step A.L), a trigger information 308 allowing a UE to perform a trigger procedure 310, e.g., to trigger a transmission of a second part 306_2 of the initial access information 300, and by transmitting, e.g., in an on-demand step 304 (e.g., steps M+1 to step N, where N is a natural number greater than M), the second part 306_2 of the initial access information 300 in response to the trigger procedure 310, such as a reception of a trigger signal. As shown in FIG. 8, when the second sequence of steps is to be broadcast on-demand, a third sequence of steps is broadcast containing at least information needed to perform a trigger procedure.

In some embodiments, the presence of additional steps and trigger procedure can be associated to a network energy saving mode, such as, for example, a Cell DTX/DRX activated mode, and the presence of the second part of the sequence of steps can be associated to another network mode, such as, for example, Cell DTX/DRX de-activated mode.

In embodiments, the always-on step may contain an indication to differentiate whether on-demand steps or additional steps are performed/broadcast. In some embodiments, this indication can signal to the UE whether the network is on an energy saving mode or not.

In embodiments, the additional steps may occur in parallel to the always-on steps, e.g., integrated on the same messages of the always-on steps, or after the always-on steps, e.g., on separate messages.

In embodiments, the combination of the always-on steps and the on-demand steps may correspond exactly to a sequence of steps supported by legacy UEs and UEs, which do not support the additional steps and the triggering procedure.

In embodiments, the network may send a signal, processed by the UEs, where the signal may indicate that the network is about to switch between broadcasting/receiving on-demand steps or additional steps. This signal may contain a timer or a counter to indicate when the change in broadcasting/receive mode occurs. Several embodiments are possible, such as, for example:
A timer and/or counter is sent during the always-on steps to indicate that the network is about to switch from one mode to another.
A timer and/or counter is sent during the on-demand steps to indicate that the network is about to switch from broadcasting/receiving the on-demand steps to broadcasting/receiving the additional steps.
A timer and/or counter is sent during the additional steps to indicate that the network is about to switch from broadcasting/receiving the additional steps to broadcasting/receiving the on-demand steps.
A combination thereof (e.g., of two or more of the previous bullet points).

In embodiments, the additional steps may contain a reduced set of the information which is normally (FIG. 7) broadcast in the (potentially) on-demand steps.

After the additional steps the UE may perform the trigger action. Then the gNB may resume regular broadcasting of the second sequence of steps and the UE may continue with initial access performing the remaining second sequence of steps.

As a basis for some exemplary embodiments, the following sequence of (e.g., high level) steps are considered, which are followed by legacy UEs in 5G NR:

| Step | gNB broadcast and/or reception | UE actions |
|---|---|---|
| 1 | Primary Synchronization Signal | PSS search, first timing synchronization, |
| | (PSS) | frequency deviation correction |
| 2 | Secondary Synchronization Signal | SSS search |
| | (SSS) | |
| 3 | Physical Broadcast Channel / | PBCH reception, MIB extraction, |
| | Master Information Block | determining CORESET#0 configuration |
| | (PBCH/MIB) | from MIB |
| 4 | System Information Block One (SIB- | Blind decoding with System Information |
| | 1) Physical Downlink Control | Radio Network Temporary Identifier (SI- |
| | Channel (PDCCH) on CORESET#0 | RNTI) on CORESET#0 according to the |
| | CSS | designed Common search space (CSS) |
| 5 | System Information Block One (SIB- | SIB-1 Decoding according to DCI_1_0 |
| | 1) Physical Downlink Shared | information |
| | Channel (PDSCH) | |
| 6 | Other SIBs | Obtained from schedule or on-demand |
| 7 | Random Access Channel (RACH) | Random Access (RA) procedure (if |
| | reception | needed - otherwise just camp) |

Splitting the sequence of steps on different places lead to different embodiments with alternative structures.

For example, one embodiment may be defined as follows:
Always-on steps:
   1—PSS
   2—SSS
(Potentially) on-demand steps—performed when the network is not on energy saving mode or after a trigger procedure:
   3—PBCH/MIB
   4—SIB-1 PDCCH on CORESET #0 CSS
   5—SIB-1 PDSCH
   6—Other SIBs
   7—RA procedure
Additional steps—performed when the network is on energy saving mode:
   A—Alternative PBCH/MIB

Another embodiment may be split in a different point:
Always-on steps:
   1—PSS
   2—SSS
   3—MIB/PBCH
   4—SIB-1 PDCCH on CORESET #0 CSS
(Potentially) on-demand steps—performed when the network is not on energy saving mode or after a trigger procedure:
   5—SIB-1 PDSCH
   6—Other SIBs
   7—RA procedure
Additional steps—performed when the network is on energy saving mode:
   A—New SIB PDCCH on CORESET #0 CSS
   B—New SIB PDSCH

In embodiments, the information to be able to perform a Trigger Procedure (TP) is hereafter called TP-Info.

Each split point and embodiment come with unique challenges and, therefore, the need for specific solutions. For this reason, the next subsections describe specific embodiments including specific solutions.

In all these embodiments, a part (or even whole) of the basic information needed for initial access may be omitted and instead broadcast on-demand. At least in the case this information is omitted, the network signals a TP-Info to UEs, which contains the parameters needed such that the UE can perform a Trigger Procedure (TP).

After a TP, the UE expects that the network will send to it the remaining part of the basic information needed for initial access, e.g., resuming its broadcast.

TP-Info may be sent also in the case the information is not omitted.

### 1. SIB-1 On-Demand with New DCI Signaling

In this embodiment SIB-1 may be sent on-demand. The first sequence of steps correspond to regular SSB reception and the second sequence of steps correspond to regular SI reception.

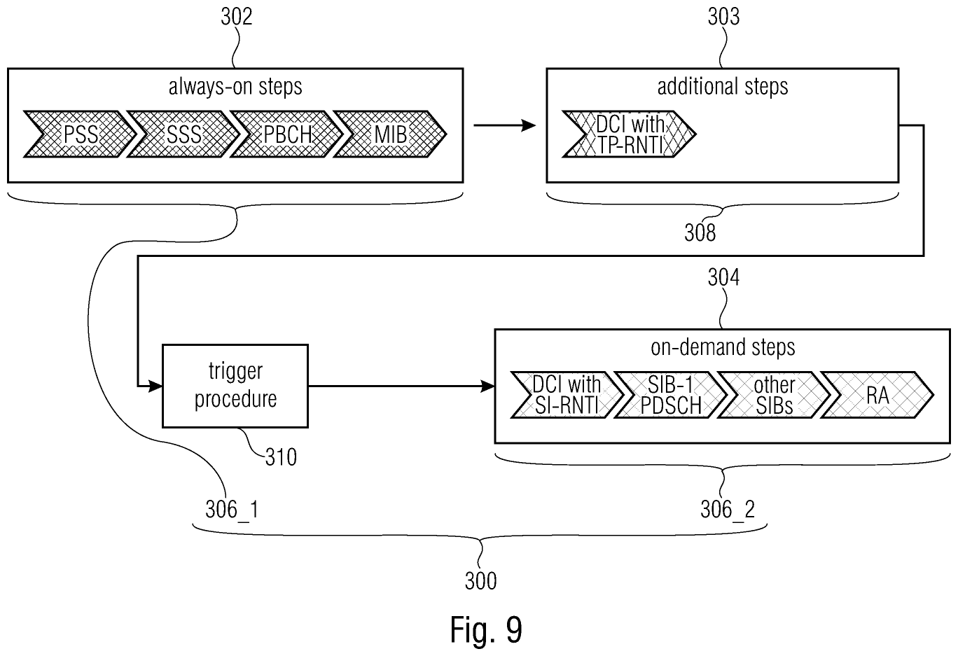

The information needed for the trigger procedure can be encoded on a new DCI format corresponding to the additional steps. This new DCI may be sent on the already defined CORESET #0 and the corresponding the Common Search Space (CSS), but in order to differentiate whether the on-demand or additional steps are sent a different RNTI (not SI-RNTI) may be used. The concept is illustrated FIG. 9.

Specifically, FIG. 9 is a schematic representation of a transmission of initial access information 300 by transmitting, as always on steps 302, a first part 306_1 of the initial access information 300, by transmitting, as an additional step 303, a trigger information 308 allowing a UE to perform a trigger procedure 310, e.g., to trigger a transmission of a second part 306_2 of the initial access information 300, and by transmitting, as on-demand steps 306_2, the second part 306_2 of the initial access information 300 in response to the trigger procedure 310, e.g., a reception of a trigger signal. Thereby, the first part 306_1 of the initial access information 300 can comprise PSS, SSS, PBCH and MIB, where the trigger information 308 can comprise DCI with TP-RNTI, where the second part 306_2 of the initial access information 300 can comprise DCI with SI-RNTI, SIB-1 on PDSCH, other SIBs and RA.

In other words, FIG. 9 shows a specific embodiment with split point between SSB and SIB-1 (for SIB-1 on-demand case). The information of the trigger procedure is included on a new DCI format scrambled with a new DCI (here named TP-RNTI—Trigger Procedure Radio Network Temporary Identifier).

This embodiment is advantageous for several reasons. First and foremost, the SSB is left untouched and fully compatible with legacy UEs. Second, the differentiation between broadcasting the second sequence of steps (SIB-1) or the third sequence of steps (trigger procedure information) relies on the pre-existing mechanism of scrambling with different RNTIs. The legacy UEs will automatically not attempt to decode the new information (TP-Info), but the new UEs can monitor PDCCH in CORESET #0 for both SI-RNTI and TP-RNTI. In fact, as long as there is enough capacity on CORESET #0 nothing prevents to schedule both information with SI-RNTI and TP-RNTI when the gNB decides to that (e.g., this can be used for advantage in a variation of the embodiment described further below where SIB-1 is not fully omitted but just transmitted less often). This also means that the gNB can swiftly change between broadcasting SIB-1 or TP-info. Switching between these two modes may be done at gNB discretion or as a response to the UE performing a TP. Last, but definitely not least, the energy savings are considerable even when the TP information is always broadcast. That is because the CORESET #0 only occupies 1-3 symbols whereas the SIB-1 PDSCH information quite often occupies the remainder of a slot. As long as the gNB hardware supports symbol shutdown (microsleep), this approach can preserve most of the energy normally spent on SIB-1. As a potential drawback the DCI can only carry a very limited amount of signaling and therefore the amount of information sent there can be carefully designed to be very efficient and yet reduced to the bare minimum.

Note that the name Trigger Procedure RNTI (TP-RNTI) is used herein by way of example, but other meaningful names could be used as well, for example, On-demand SIB-1 (ODSI-RNTI) or Cell-Wake-Up-Signal RNTI (C-WUS-RNTI). No matter the name, the concept is a new RNTI which carries information which allows the UE to perform the trigger procedure for SIB-1 on-demand.

In some versions of this embodiment instead of completely omitting SIB-1, SIB-1 may be transmitted with a reduced periodicity. For example, SIB-1 may be transmitted every 160 ms (e.g., one repetition within its 160 ms) or 80 ms (e.g., two repetitions within its 160 ms period). In this case, the DCI may include some information regarding when the next regular SIB-1 transmission takes place. In this way, the UE may decide whether it is better to wait for the less frequent SIB-1 transmission (e.g., for a non-time critical operation) or to trigger SIB-1 on-demand with regular periodicity (e.g., for time critical operation). In the case of a reduced SIB-1 repetition rate, the trigger to SIB-1 on-demand may be used to restore a regular SIB-1 repetition rate, e.g., 20 ms in FR1 or same as SSB in FR2.

When SIB-1 on-demand is triggered the SIB-1 may be transmitted for a fixed number of times, e.g., 1, 2, 4, 8, 10, 16, . . . , N or for a fixed amount of time, e.g., 160 ms, 320 ms, 640 ms, etc. until the network stops again the transmission of SIB-1 and instead transmit TP-info.

As an alternative, in some variations of this embodiment, a separate CORESET or different search space could be configured for sending TP-info. Such CORESET and search space may be specific for each band, depending, e.g., on minimum system bandwidth, SSB SCS, PDCCH SCS and multiplexing pattern between SSB and PDCCH (CORESET #0 or TP-CORESET). For simplicity, hereafter it is referred to TP-CORESET as the CORESET where DCI with TP-Info is sent. TP-CORESET may be CORESET #0, another existing CORESET or a newly defined CORESET. If a new CORESET is defined for TP-CORESET that differentiation is enough and SI-RNTI may be reused as SI-RNTI.

If an alternative search space is defined, this new search space may only occupy one symbol in order to minimize the energy consumption. The existing CSS for CORESET #0 may occupy 1-3 symbols.

### 1.1 DCI Design

In embodiments, the DCI carrying TP-info may only carry a very limited amount of information and yet provide the UE with enough information to carry out a triggering procedure.

In embodiments, the exact content of the DCI depends on how the triggering procedure looks like (see section 8). Here are some exemplary embodiments:
The TP can be a Cell Wake-Up Signal (C-WUS) sent on the same carrier/cell. For example, in this case, at the very minimum such DCI can carry enough information such that the UE can determine which time and frequency resources on an OFDM grid can be used for sending C-WUS. If the signal is to be sent on the same carrier as the DCI (e.g., Time Division Duplex (TDD)) this may be a time and frequency offset, for example an entry value on a table where such time and frequency offset can be determined. If another band is used for uplink (e.g., Frequency Division Duplex (FDD), Supplementary Uplink (SUL)), this may be instead an indication of that frequency (e.g., Absolute Radio Frequency Channel Number (ARFCN)). In addition to that, information about a PRACH sequence may be provided and/or information which allows the UE to determine the transmit power for the C-WUS. This may be for example the transmit power which was used for PBCH, such that the UE can determine the path loss, and power control parameters such as the target received power.
The TP can be a C-WUS sent on another carrier/cell. For example, in this case, the DCI can contain information on how to access the other band such as the frequency which the carrier can be found (e.g., a AFRCN offset or Global Synchronization Channel Number (GSCN) offset) and may contain also timing information, e.g., SSB periodicity and/or time to next SSB on the target band/cell (other cell). Such information may be repeated for different cells/bands where the TP can be performed.
The TP can be sent via an LTE cell. For example, it may contain the frequency of the LTE cell (e.g., E-UTRA Absolute Radio Frequency Channel Number (EARFCN)).
The TP can be sent via sidelink. For example, the DCI may contain information about a SL resource pool where the TP can be performed.

In embodiments, if more than one type of TP is possible to support multiple cases, e.g., both sending C-WUS on the same carrier and another carrier are supported, then also the DCI may have information to distinguish which of these TP cases is currently signaled.

Before reading SIB-1, a UE has reduced knowledge about the cell which is being accessed. In fact, unless the UE already has cached information about that cell, the UE does not even have knowledge whether that cell belongs to a network to which it has access. Also, in between two accesses of the same cell the network may have put the cell to a barred status. Thus, there are several types of information which are not strictly needed to perform a TP, but they may need to be sent quite early (e.g., before a TP) because of performance needs. Therefore, the DCI may also contain early information which provides some part of the information present on SIB-1, for example, on a condensed way. This can be for example:
The DCI may contain an indication whether the cell is barred or not—e.g., for those UEs which ignore barring from MIB and read barring information from SIB-1.
The DCI may contain indication(s) if certain groups of UEs (e.g., Non Terrestrial Network (NTN), redcap with 1Rx, redcap with 2RX, etc.) can consider the cell as barred or not.
The DCI may contain a one bit indication whether IMS emergency calls are supported or not.
The DCI may contain a one bit indication whether IMS eCalls are supported or not.
The Public Land Mobile Network (PLMN) (Mobile Country Code and Mobile Network Code (MCC+MNC)) can be hashed to a target number of bits (e.g., 8 or 16) and sent on the DCI. Another bit on the DCI may control whether the DCI provides this hashed PLMN information or not. A UE reading this hashed PLMN field, can apply the same hashing function to PLMNs it know it has access (e.g., those PLMNs listed in one of its SIM cards). If there is a match between this field and the hashed PLMN, the UE continues accessing this cell and may start a TP. If there is no match, the UE declares the cell as not feasible. The same logic of hashing may apply to Stand-alone Non-Public Network (SNPN) identities. A list of PLMN-identity hashes or a list of SNPN-identity hashes may be provided or only the first n may be provided.
The DCI may contain information which allows the UE to further refine synchronization or the understanding of where signals are expected (e.g., where in the frame the current signaling is located). This information may be repeated from SIB-1 in the DCI, such as one or more out of:
   SSB positions in burst,
   SSB periodicity in serving cell,
   a description of the TDD pattern,
   time alignment information,
   offset to point A.

One concrete example of DCI in this embodiment is a DCI with one of more of the following fields:
TP-info index (e.g., 4 bits)—The UE uses this index to look up in tables for predefined configurations of time, frequency and RACH preamble used for performing TP.
First PLMN or NPN hash (e.g., 8 bits)—CRC-8 of the PLMN identity or SNPN identity as represented in SIB-1. The hashed identity is the first PLMN on the list.
Other PLMNs or NPN present (e.g., 1 bit)—True if this cell has more PLMNs or SNPNs whose identities are not present on this DCI.
Barring on SIB-1 (e.g., 1 bit)—This field indicates that the cell is barred, and UEs which ignore MIB barring, or need to evaluate MIB barring jointly with SIB-1 barring.
SS PBCH Block power (e.g., 7 bits)—This field corresponds to ss-PBCH-BlockPower in SIB-1. The value on this field can be summed to MIN_PBCH_POWER (e.g., −50) to obtain SS PBCH block power in dBm.
Target received power (7 bits)—The value on this field can be subtracted from MAX_TARGET_RX_POWER_CWUS (e.g., −74 dBm) to obtain the target C-WUS received power in dBm
Power ramping step (e.g., 2 bits)—00-0 dB, 01-2 dB, 10-4 dB, 11-6 dB.
PRACH configuration index (e.g., 8 bits)—PRACH configuration as in [5], where the RACH preamble can be used for triggering procedure.
In FR2 only the DCI include ssb positions in burst (e.g., 16 bits).

Naturally, this is just exemplary and, for example, the PLMN hash could be any hashing function which results in 8 bits (e.g., Pearson hashing), or TPinfo index could have any number of bits. Power ramping step could have other mappings. Also the exemplary values for MIN_PBCH_POWER (−50) and MAX_TARGET_RX_POWER_CWUS (−74 dBm) were chosen to be consistent with SIB-1 values but other embodiments may consider different values.

### 1.2 Multiplexing Pattern

In embodiments, in order to have a full coverage, the DCI with TP-info (e.g., within TP-CORESET) also can be beamformed on different directions (e.g., on the same way SSBs and SIB-1s typically are). Therefore, multiplexing patterns can be defined which allow for efficient beamforming. For example, for the case of CORESET #0 as TP-CORESET, multiplexing patterns 1 (on FR1) and multiplexing patterns 2 and 3 (on FR2) as described in [4]can be referred to.

In order to reduce (or even minimize) energy consumption and provide efficient beam sweeping of SSBs+TP-info or beam sweeping of SSB+SIB-1 this embodiment can be combined with the adoption of SSB/CORESET #0 multiplexing pattern 2 and 3 also on FR1, namely that CORESET #0 and SIB-1 PDSCH are frequency multiplexed with the SSB.

Alternatively, if a new CORESET is defined as TP-CORESET for TP-info the frequency multiplexing to SSB may be applied to TP-CORESET while CORESET #0 remains backward compatible.

Another option to reduce energy consumption and allow efficient beam sweeping of SSB+TP-Info (which may also be applied to SSB+SIB-1) is to use a new multiplexing pattern which has the TP-CORESET on the same slot as SSB but on different symbols, for example the CORESET being 1 or 2 symbols before the SSB. In case this new multiplexing pattern is also applied to SIB-1 (TP-CORESET is CORESET #0), or some other PDSCH is needed as a complement (see section 7), the PDSCH pattern of the new multiplexing pattern may be sent on the remaining symbols and/or parallel to SSB.

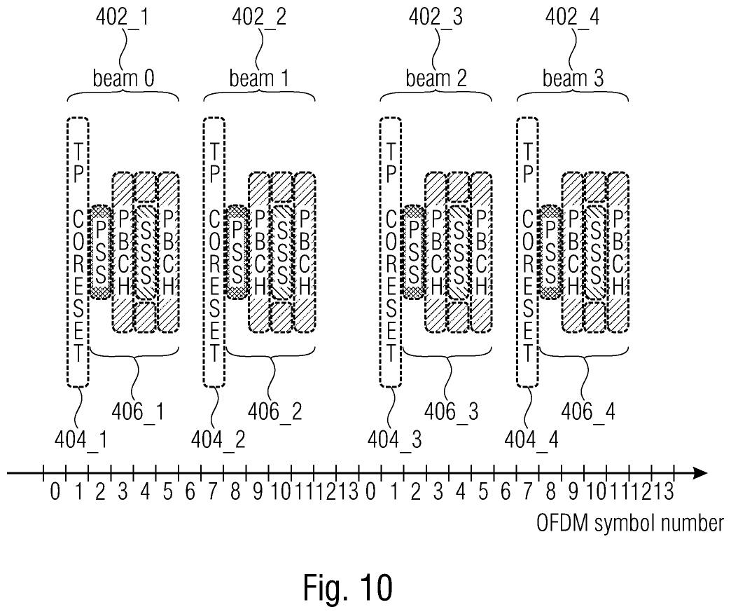

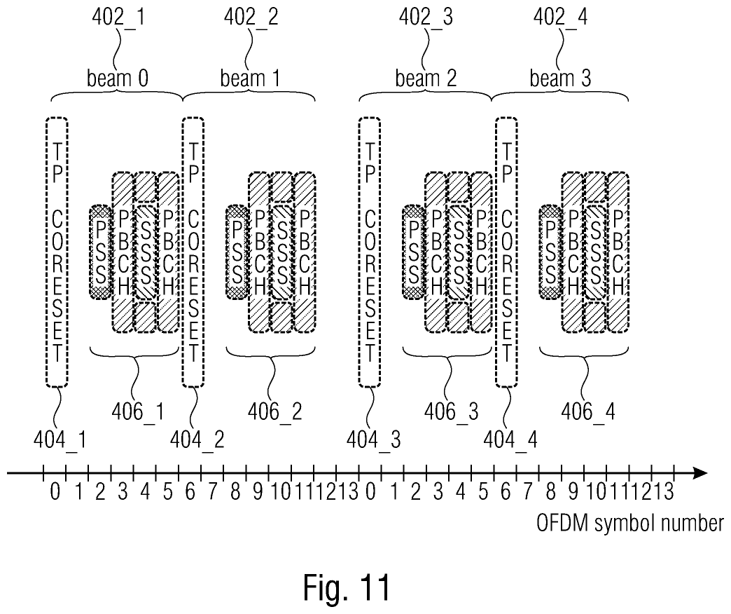

In embodiments, two new multiplexing patterns between a CORESET and SSB are considered. These patterns are designed and suitable for TP-CORESET, but could also be used for CORESET #0. In embodiments it is defined:
Multiplexing pattern 4: TP-CORESET is on the same slot as SSB and transmitted prior to SSB.
Multiplexing pattern 5: TP-CORESET is on the same slot as SSB and transmitted after SSB. [4]defines SSB locations on OFDM grid for many different cases (A to G) in different SCS configurations. The definition above may apply to any of these cases, but for simplicity the concept is illustrated for one specific case, namely case A below 3 GHz. FIGS. 10, 11 and 12 exemplify multiplexing pattern #4 with 1 or 2 symbols TP-CORESET and a potential gap between TP-CORESET and SSB (present on FIG. 11).

Specifically, FIG. 10 shows a schematic representation of a multiplexing pattern with four beams 402_1 to 4024, where in each beam 402_1 to 402_4 trigger information and a first part of access information are multiplexed, where the trigger information is transmitted on one symbol TP-CORESET 404_1 to 404_4 before the first part of the access information 406_1 to 406_4. In FIG. 10, by way of example, a SSB is transmitted as first part of the access information 406_1 to 406_4, e.g., comprising PSS, PBCH and SSS. In other words, FIG. 10 shows a schematic representation of TP-CORESET multiplexing pattern #4 (before SSB) with one symbol TP-CORESET and no gap between CORESET and SSB.

FIG. 11 shows a schematic representation of a multiplexing pattern with four beams 402_1 to 402_4, where in each beam 402_1 to 402_4 trigger information and a first part of access information are multiplexed, where the trigger information is transmitted on one symbol TP-CORESET 404_1 to 404_4 with a gap before the first part of the access information 406_1 to 406_4. In FIG. 11, by way of example, a SSB is transmitted as first part of the access information 406_1 to 406_4, e.g., comprising PSS, PBCH and SSS. In other words, FIG. 11 shows a schematic representation of TP-CORESET multiplexing pattern #4 (before SSB) with one symbol TP-CORESET and a gap between TP-CORESET and SSB present.

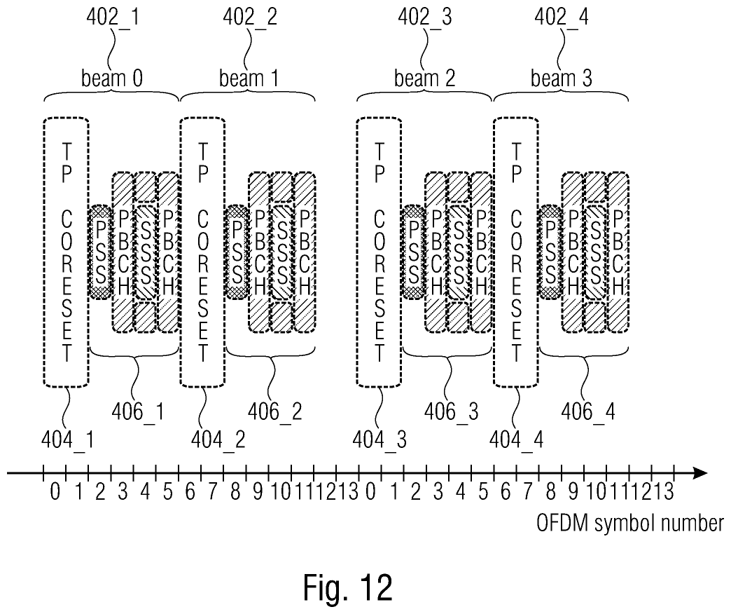

FIG. 12 shows a schematic representation of a multiplexing pattern with four beams 402_1 to 402_4, where in each beam 402_1 to 402_4 trigger information and a first part of access information are multiplexed, where the trigger information is transmitted on two symbols TP-CORESET 404_1 to 404_4 before the first part of the access information 406_1 to 406_4. In FIG. 12, by way of example, a SSB is transmitted as first part of the access information 406_1 to 4064, e.g., comprising PSS, PBCH and SSS. In other words, FIG. 12 shows a schematic representation of TP-CORESET multiplexing pattern #4 (before SSB) with 2 symbol TP-CORESET.

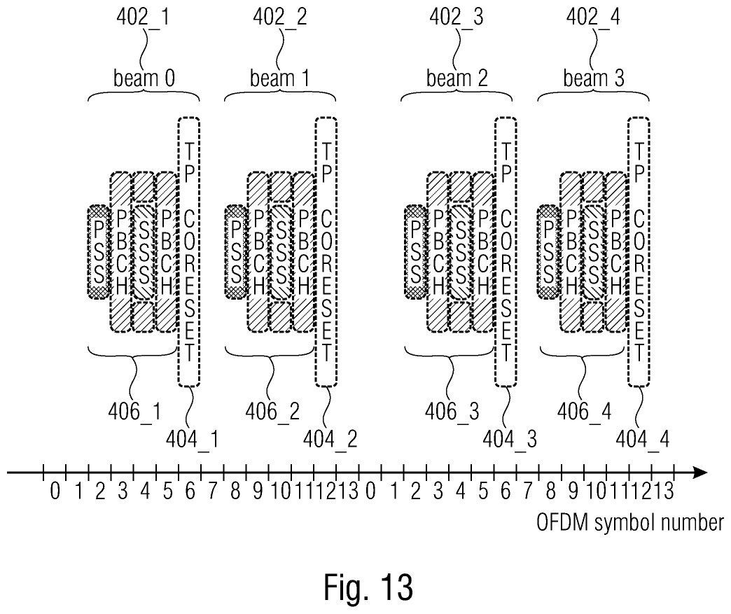

FIG. 13 shows a schematic representation of a multiplexing pattern with four beams 402_1 to 402_4, where in each beam 402_1 to 402_4 trigger information and a first part of access information are multiplexed, where the trigger information is transmitted on one symbol TP-CORESET 404_1 to 404_4 after the first part of the access information 406_1 to 406_4. In FIG. 13, by way of example, a SSB is transmitted as first part of the access information 406_1 to 4064, e.g., comprising PSS, PBCH and SSS. In otherwords, FIG. 13 illustrates multiplexing pattern #5 where the TP-CORESET is transmitted just after the SSB. This realization of this embodiment with a new multiplexing pattern allows to have common signals tightly packed in time, allowing for extra energy savings.

In embodiments, an indication of alternative multiplexing pattern may be sent on PBCH, MIB or the UE may try multiple multiplexing patterns (e.g., multiplexing pattern 1 and 4) to figure out where CORESET #0 and TP-CORESET are located.

### 2. PBCH/MIB+SIB-1 On-Demand

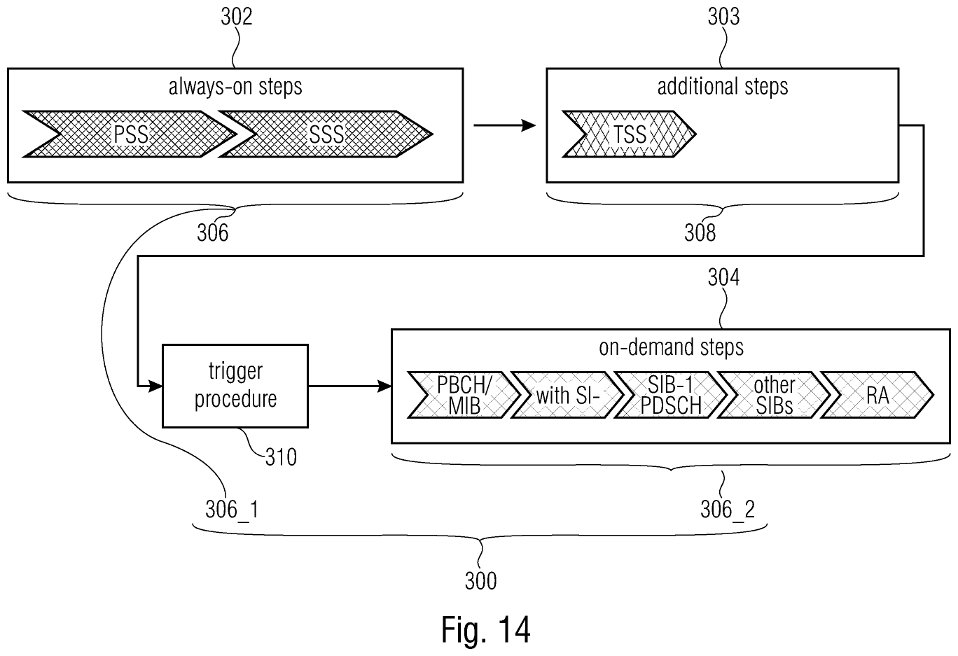

In this embodiment, PSS+SSS are broadcast normally, so that the UE can detect the cell during cell search/initial access. However, instead of PBCH/MIB being broadcast a new signal, a Tertiary Synchronization Signal (TSS) is sent to describe that PBCH/MIB/SIB-1 can be sent on-demand. The process of this embodiment is illustrated in FIG. 14, which shows in a schematic representation PBCH/MIB/SIB-1 on-demand with a TSS.

Specifically, FIG. 14 is a schematic representation of a transmission of initial access information 300 by transmitting, as always on steps 302, a first part 306_1 of the initial access information 300, by transmitting, as an additional step 303, a trigger information 308 allowing a UE to perform a trigger procedure 310, e.g., to trigger a transmission of a second part 306_2 of the initial access information 300, and by transmitting, as on-demand steps 306_2, the second part 306_2 of the initial access information 300 in response to the trigger procedure 310. Thereby, the first part 306_1 of the initial access information 300 can comprise PSS and SSS, where the trigger information 308 can comprise a TSS, where the second part 306_2 of the initial access information 300 can comprise PBCH/MIB with SI, SIB-1 on PDSCH, other SIBs and RA.

In embodiments, the TSS is a sequence which can be detected with the same correlators as PSS and/or SSS to avoid increased hardware costs. Also, in embodiments, the TSS can be sent on the same OFDM symbols as PSS or SSS in order to reduce energy consumption, i.e., allow symbol shutdown when PBCH/MIB are not sent.

Different sequences on TSS may point to a number of pre-defined configurations, which can be used to perform a TP, e.g., send a C-WUS to start the chain PBCH/MIB/SIB-1 on-demand.

### 3. PBCH/MIB Based Embodiment for SIB-1 On-Demand

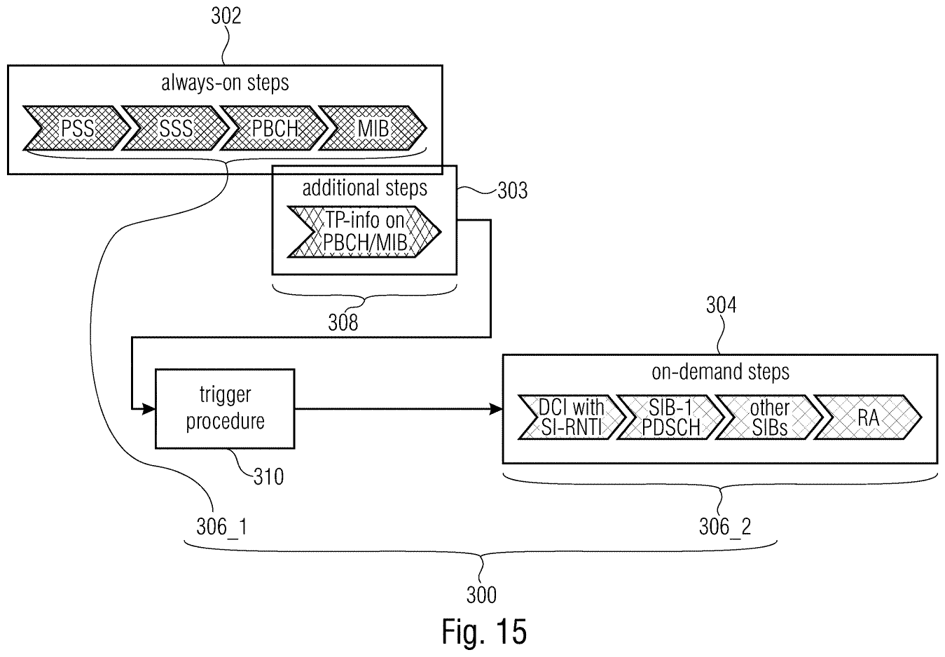

For the sake of backward compatibility the whole PBCH and MIB may be transmitted as in legacy, but containing TP-info on the PBCH/MIB. This is illustrated on FIG. 15, which shows a schematic representation of an embodiment based on TP-Info present on PBCH/MIB.

Specifically, FIG. 15 is a schematic representation of a transmission of initial access information 300 by transmitting, as always on steps 302, a first part 306_1 of the initial access information 300, by transmitting, as an additional step 303, a trigger information 308 allowing a UE to perform a trigger procedure 310, e.g., trigger a transmission of a second part of the initial access information, and by transmitting, as on-demand steps 306_2, the second part 306_2 of the initial access information 300 in response to the trigger procedure 310. Thereby, the first part 306_1 of the initial access information can comprise PSS, SSS, PBCH and MIB, where the trigger information 308 can be transmitted on PBCH/MIB, where the second part 306_2 of the initial access information 300 can comprise DCI with SI-RNTI, SIB-1 on PDSCH, other SIBs and RA.

Note that in FIG. 15, the additional steps are illustrated in parallel to part of the first sequence of steps, just to make clear that the first and additional steps may be done in parallel in different embodiments and in particular in this one.

In embodiments, the signaling may be obtained on the field K_ssb, derived from ssb-SubcarrierOffset on MIB and the PBCH encoding. One or more special values of K_ssb, for example K_ssb=30 for FR1 and K_ssb=14 for FR2, can indicate that the cell is currently not broadcasting SIB-1 but it can broadcast SIB-1 on-demand. The UE can re-interpret the field pdcch-ConfigSIB1 to acquire the information needed performing the triggering procedure, i.e. TP-info is encoded on pdcch-ConfigSIB1. As only 8 bits are available in pdcch-ConfigSIB1, TP-info has to be absolute minimal. A possible way is to divide the bits of TP-Info (pdcch-ConfigSIB1):
n bits for a reduced indication of SS PBCH Block (e.g., n=5), and
8-n bits for an index to a predefined set of TP-information (time/frequency offset, RACH preamble, etc).

Alternatively, the PBCH/MIB can contain a separate indication that SIB-1 on-demand is possible, for example using the one spare bit on MIB. In this case both k_ssb/ssb-SubcarrierOffset and pdcch-ConfigSIB1 may be reinterpreted as information which forms TP-Info and/or reduced indication of SS PBCH Block.

TP-Info interpretation may be subject to specific bands, on minimum system bandwidth, SSB SCS, PDCCH SCS and multiplexing pattern between SSB and PDCCH (CORESET #0 or TP-CORESET).

As SS PBCH block is normally sent with 7 bits in SIB-1, the indication here may use another granularity (e.g., 4 dB step instead of 1 dB step, for n=5).

For legacy UEs not supporting the SIB1 on-demand capability: in case the cell indicates itself as a “SIB1 on-demand” cell, (e.g., indicated by SSB/MIB), legacy UEs may consider the cell as barred and react in the same way as they would do in case the cell barred flag is set.

### 4. SSB On-Demand Embodiment

In the case of SSB on-demand all steps of regular initial access are performed on demand (both SSB and SIB-1), but as in other embodiments additional steps are needed. This may include, e.g., pre-SSB synchronization and sending TP-info.

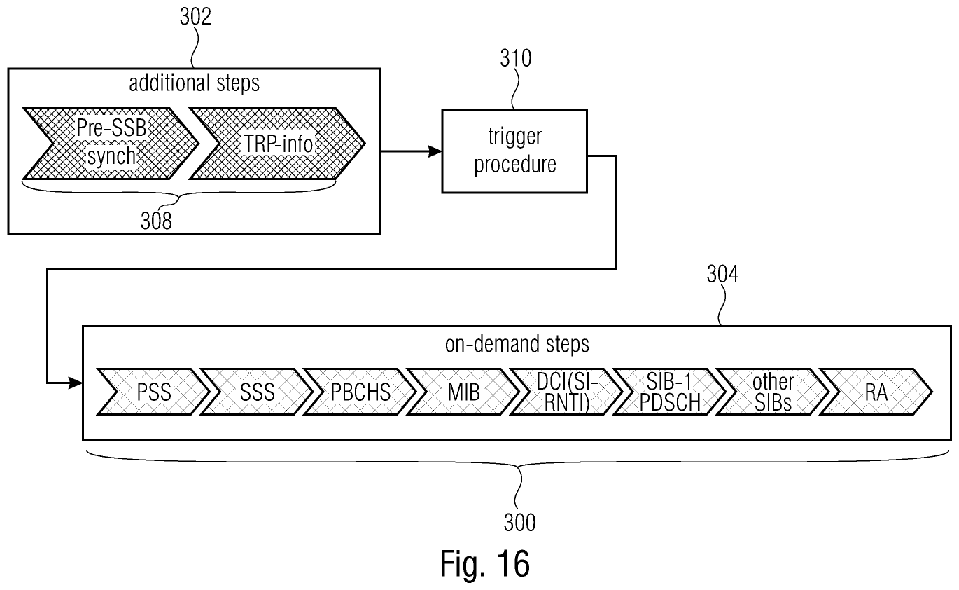

For this on-demand SSB case with more potential for NES, as depicted in FIG. 16, the always-ON steps are only the additional steps that provide needed synchronization and TP-info needed for performing the TP.

Specifically, FIG. 16 is a schematic representation of a transmission of initial access information 300 by transmitting, as an additional step 303, a trigger information 308 allowing a UE to perform a trigger procedure 310, e.g., to trigger a transmission of the initial access information 300, and by transmitting, as on-demand steps 306_2, the initial access information 300 in response to the trigger procedure 310. Thereby, the initial access information 300 can comprise PSS, SSS, PBCH and MIB, DCI with SI-RNTI, SIB-1 on PDSCH, other SIBs and RA.

In embodiments, the pre-SSB sync signal can be a reduced/light version of the regular SSB with more potential for NES through inactivity periods at the gNB than regular SSB. This pre-SSB synch, which can be a light version of the SSB, such a as a discovery reference signal (DRS) or only the PSS, provides enough time and frequency synchronization for the UE such that together with the TP-info the UE can perform the TP for demanding full transmission of SSB and SIB1 needed for completing the initial access procedures.

### 5. Extended MIB

A major drawback of the approach in section 3 is that the amount of data on which TP-Info has to be carried is so small that important but not essential information has to be left out. This issue may be overcome by extending the MIB. For this sake, the spare bit present on MIB on Rel-18 may be transformed into an indication that a MIB extension is present. In this way, other important information, such as the ones already described on section 1.1 (e.g., PLMN hash, target received power, RACH information, etc) may be then included on the MIB extension.

In embodiments, the MIB extension can contain at least one new spare bit.

In embodiments, the MIB extension can be sent on the same symbols already used for PSS, SSS and PBCH in order to avoid a large increase on energy consumption, i.e., OFDM symbols not already belonging to SSB can be shutdown.

### 6. Green Field Approach with Redesigned MIB

While backward compatibility may be present in some embodiments, it is also possible that all information needed in embodiments is sent on a newly design MIB. This is an advantageous embodiment, e.g., for a new system like 6G which can consider from the very beginning the needs for network energy savings and support a mode where the MSI is only sent on-demand. This new MIB may contain a direct indication of the support of MSI on-demand, e.g., a one bit indication (MSI on-demand supported). This new MIB may contain an index into pre-defined configurations for a C-WUS on a TP.

This new MIB may contain fields already described in other sections, e.g., barring info, PLMN or NPN hash, SS PBCH power, target received power, RACH preamble, SSB positions in burst, SSB periodicity in serving cell, a description of the TDD pattern, Time alignment information, Offset to point A, etc.

### 7. Reduced SIB-1 Including Info to Full SIB-1

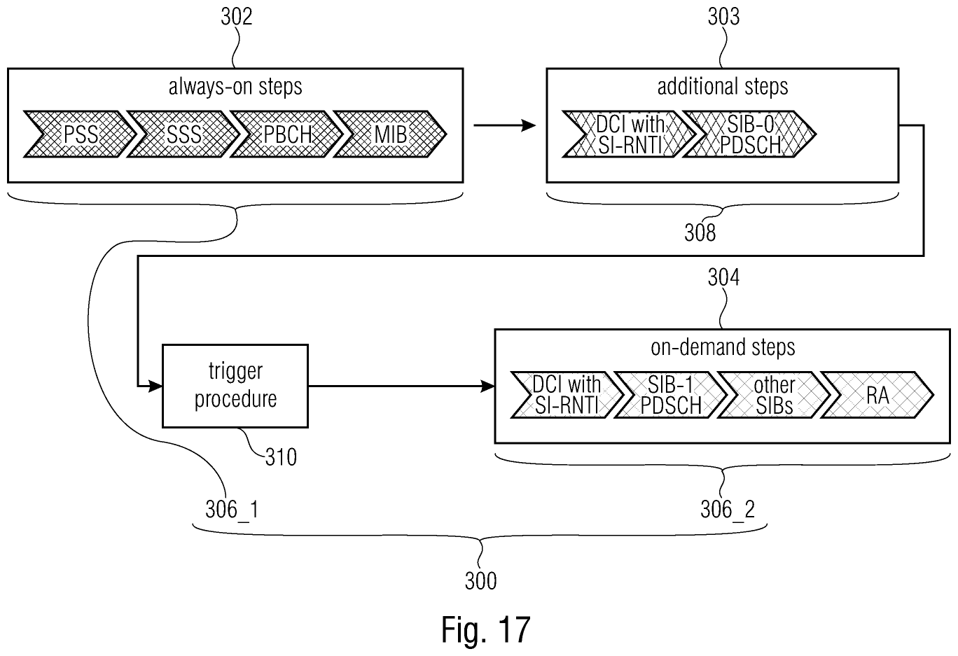

In some embodiments, TP-Info may be transmitted on PDSCH. This is particularly useful if the TP-Info to be transmitted is a reduced version of SIB-1 (RRC signaling/ASN1 can be used to describe TP-Info). For simplicity, and as an indication that this information is sent before SIB1, this reduced version is called SIB-0. This embodiment is illustrated on FIG. 17, which shows an embodiment with reduced SI.

Specifically, FIG. 17 is a schematic representation of a transmission of initial access information 300 by transmitting, as always on steps 302, a first part 306_1 of the initial access information 300, by transmitting, as an additional step 303, a trigger information 308 allowing a UE to perform a trigger procedure 310, e.g., to trigger a transmission of a second part 306_2 of the initial access information 300, and by transmitting, as on-demand steps 306_2, a second part 306_2 of the initial access information 300 in response to a trigger procedure 310. Thereby, the first part 306_1 of the initial access information can comprise PSS, SSS, PBCH and MIB, where the trigger information 308 can comprise DCI with SI-RNTI, where the second part 306_2 of the initial access information can comprise DCI with SI-RNTI, SIB-1 on PDSCH, other SIBs and RA.

This embodiment can be implemented with an existing SI-RNTI. One of the reserved bits in DCI_1_0 scrambled with SI-RNTI can be defined to expand the field “System information indicator” from 1 bit to 2 bits. For example, a new value can be added to Table 7.3.1.2.1-2 in [6] to inform the UE about the information needed to perform a trigger procedure for on-demand SSB and/or MSI. This may be e.g., “TP Info”, “C-WUS info”, “SIB-0”, or “pre-SIB-1” value. Also, nothing prevents to have a new RNTI for this case but it is not strictly needed.

This embodiment has a drawback that a PDSCH transmission is needed, potentially leading to reduced energy savings. Therefore, this embodiment only makes sense if the information needed to do the Trigger Procedure (TP) is much less than the information on the full SIB-1. One potential implementation is that SIB-0 only contains the fields needed to start TP. For example, the existing mechanism to trigger other-SI on-demand can be reused and SIB-0 can then contain SI-RequestConfig ([2]). Some other SIB-1 fields may be repeated in SIB-0 for the sake of performance and early determination of feasibility (e.g., similar to what was discussed on section 1.1)

### 7.1 Multiplexing Patterns

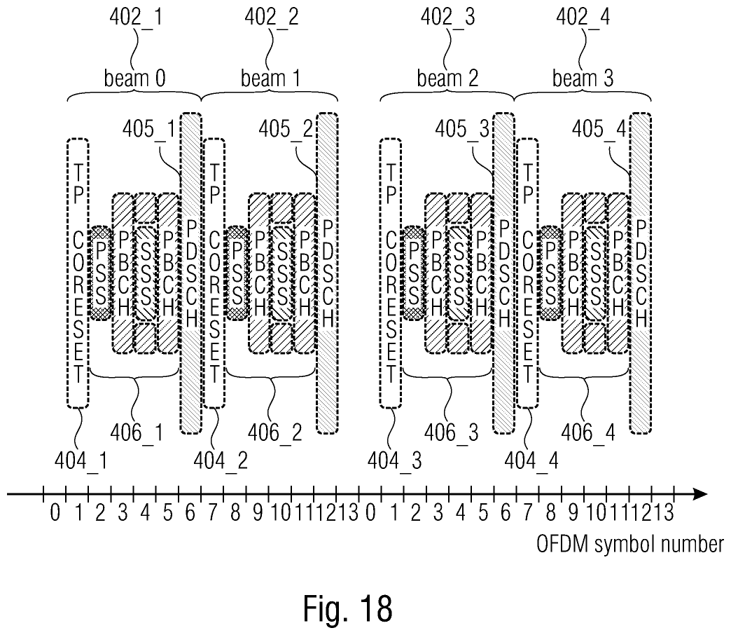

In this embodiment, TP-Info can be transmitted on PDSCH, for example, as a new (reduced) SIB also the location of PDSCH in relation to SSB and CORESET can be defined. The whole information may be packed efficiently (e.g., from energy perspective) to be transmitted to a certain beam. The multiplexing patterns considered in section 1.2 may be also extended to define the position of PDSCH in respect to SSB and CORESET (CORESET #0 and/or TP-CORESET). This is illustrated in FIGS. 18, 19 and 20.

Specifically, FIG. 18 shows a schematic representation of a multiplexing pattern with four beams 402_1 to 402_4, where in each beam 402_1 to 402_4 trigger information and a first part of access information are multiplexed, where the trigger information is transmitted on one symbol PDSCH 405_1 to 405_4 after the first part of the access information 406_1 to 406_4 and TP CORESET 404_1 to 404_4. In FIG. 18, by way of example, a SSB is transmitted as first part of the access information 406_1 to 406_4, e.g., comprising PSS, PBCH and SSS. In other words, FIG. 18 shows a schematic representation of multiplexing pattern #4 with PDSCH (carrying TP information) after SSB. TP-CORESET here may be CORESET #0. As shown in FIG. 18, the PDSCH is sent after the SSB, still resulting in transmission of all beams highly packed in time.

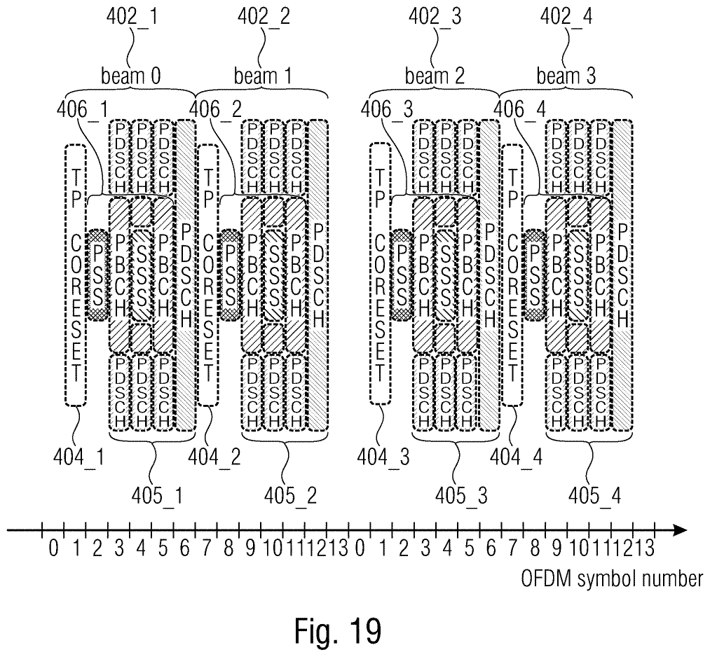

FIG. 19 shows a schematic representation of a multiplexing pattern with four beams 402_1 to 402_4, where in each beam 402_1 to 402_4 trigger information and a first part of access information are multiplexed, where the trigger information is transmitted on PDSCH 405_1 to 405_4 temporally overlapping with the first part of the access information 406_1 to 406_4 and after TP CORESET 404_1 to 404_4. In FIG. 19, by way of example, a SSB is transmitted as first part of the access information 406_1 to 406_4, e.g., comprising PSS, PBCH and SSS. In other words, FIG. 19 shows a schematic representation of multiplexing pattern #4 with PDSCH (carrying TP information) in parallel and after SSB. TP-CORESET here may be CORESET #0.

As shown in FIG. 19, the PDSCH is sent not only after the SSB but already in parallel. This may result in additional capacity for SIB-0 with little extra power consumption.

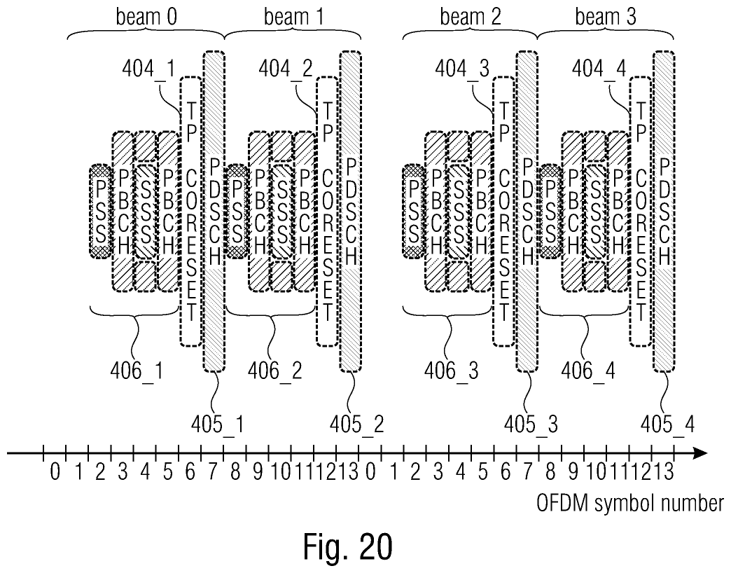

FIG. 20 shows a schematic representation of a multiplexing pattern with four beams 402_1 to 402_4, where in each beam 402_1 to 402_4 trigger information and a first part of access information are multiplexed, where the trigger information is transmitted on PDSCH 405_1 to 405_4 after the first part of the access information 406_1 to 406_4 and after TP CORESET 404_1 to 404_4. In FIG. 20, by way of example, a SSB is transmitted as first part of the access information 406_1 to 406_4, e.g., comprising PSS, PBCH and SSS. In other words, FIG. 20 shows a schematic representation of multiplexing pattern #5 with PDSCH (carrying TP information) after TP-CORESET. TP-CORESET here may be CORESET #0. In other words, FIG. 20 illustrates a potential position for SIB-0 PDSCH on multiplexing pattern #5.

### 8. Gradual Information

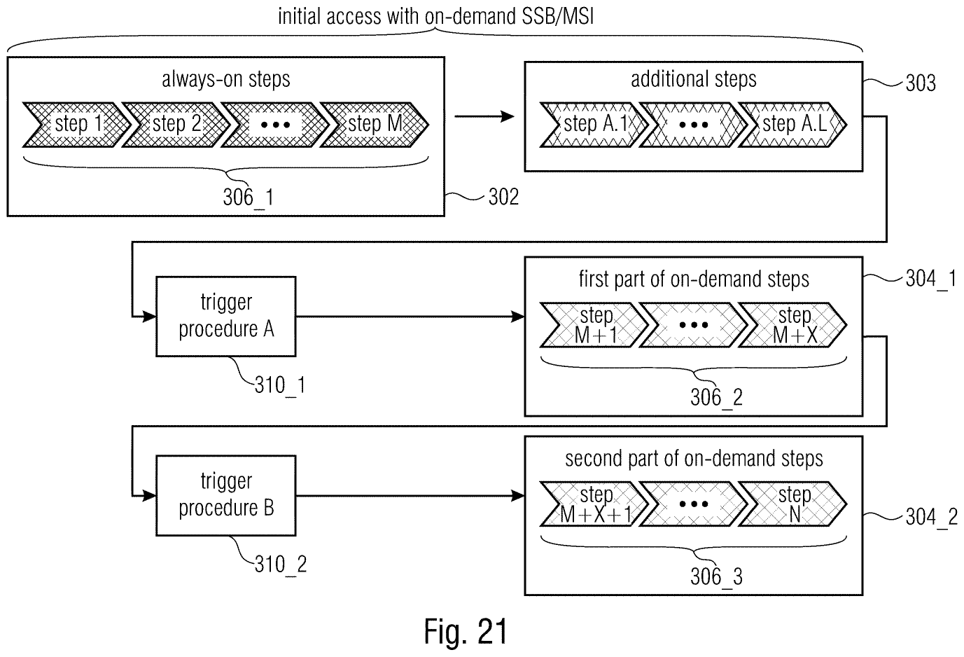

In some embodiments it is possible that the information is gradually sent based on multiple triggering procedures. This is illustrated in FIG. 21, which shows a schematic representation of a generalized procedure with multiple trigger procedures.

Specifically, FIG. 21 is a schematic representation of a transmission of initial access information 300 by transmitting, e.g., in an always on step 302 (e.g., step 1 to step M, where M is a natural number greater than or equal to one), a first part 3061 of the initial access information 300, by transmitting, in an additional step 303 (e.g., step A.1 to step A.L), a trigger information 308 allowing a UE to perform at least a first trigger procedure 310_1, e.g., to trigger a transmission of a second part 306_2 of the initial access information 300, by transmitting, e.g., in a first on-demand step 304_1 (e.g., steps M+1 to step M+X, where N is a natural number greater than M), the second part 3062 of the initial access information 300 in response to the first trigger procedure 310_1, and by transmitting, e.g., in a second on-demand step 304_2 (e.g., steps M+X+1 to step N, where N is a natural number greater than M+X), the third part 306_3 of the initial access information 300 in response to the second trigger procedure 310_2.

In comparison to the basic procedure (cf. FIGS. 7 and 8), the initial access is divided into more than two sequence of steps and each Trigger procedure (TP) activates a further sequence of steps.

### 9. Triggering Via Sidelink Relay

In release 17 and release 18 3GPP worked on sidelink relaying techniques where source remote UEs connect via a sidelink (PC5) to a relay UE that is forwarding information to target remote UEs (U2U case) or a base station (U2N case) or another transceiver that is using a 3GPP or non-3GPP connection.

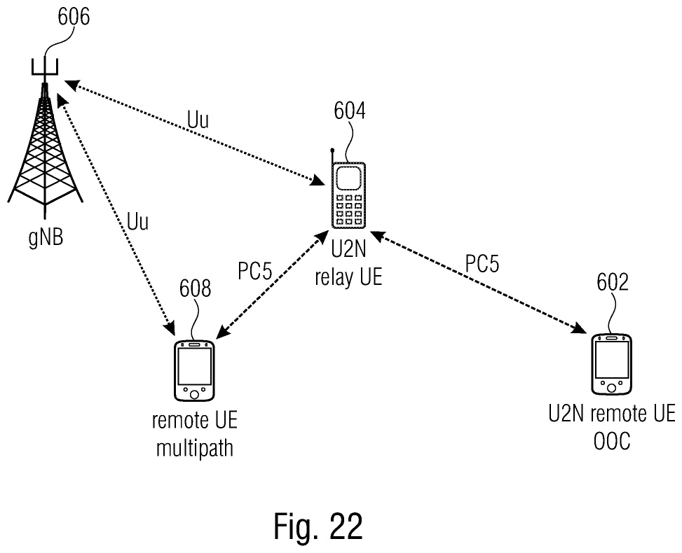

FIG. 22 shows a schematic representation of an exemplary sidelink relaying scenario. As shown in FIG. 22, an out of coverage (OOC) U2N remote UE 602 can communicate over a sidelink (e.g., using the PC5 interface) via a U2N Relay UE 604 with a gNB 606, where the U2N Relay UE 604 forward information to or from the gNB 606 using a Uu interface. Moreover, another UE 608 might be connected to both, the U2N Relay UE 604 and directly to the gNB 606, thereby exploiting multipath advantages.

In embodiments, a remote UE can establish a RRC connection to a network (e.g., base station or MNO network) via a relay UE. This connection can be established while the UE is in OOC or IC, as long as the relay UE can establish a connection to a network or other transceiver.

In embodiments, if the remote UE is within the coverage of a base station in DTX mode, there might be no signals or only partial signals broadcasted in the cell. If the relay UE already has a connection to the cell or another cell, the remote UE can signal—via the relay—that it is requesting the cell to broadcast a minimum set of system information (e.g., MIB, SIB-0, SIB-1).

In embodiments, the relay UE is not required to be connected to the same cell, but could forward the information to the network to decide whether and which cells to configure to start broadcasting system information.

In embodiments, the cell wake-up signal is sent either as MAC CE, RRC or another form of control message from the remote UE via one or multiple relay UEs to one or multiple cells on the same or another frequency.

In embodiments, the relay UE can also forward the information in downlink. Which would include sending the TP to the UEs out of coverage. This would help the out of coverage UE to figure out the format and extract the information needed for triggering the downlink signals.

In embodiments, in case the UE is entering the cell and reaches a point which is in coverage of the cell, it can trigger the procedure itself or as described above, it can trigger the procedure using the relay UE.

In this case, the relay UE specially on cell edge may continue to broadcast the information for a while so that the UEs who are handing over to the cell can know in advance how they can access the additional information and trigger the cell to send them.

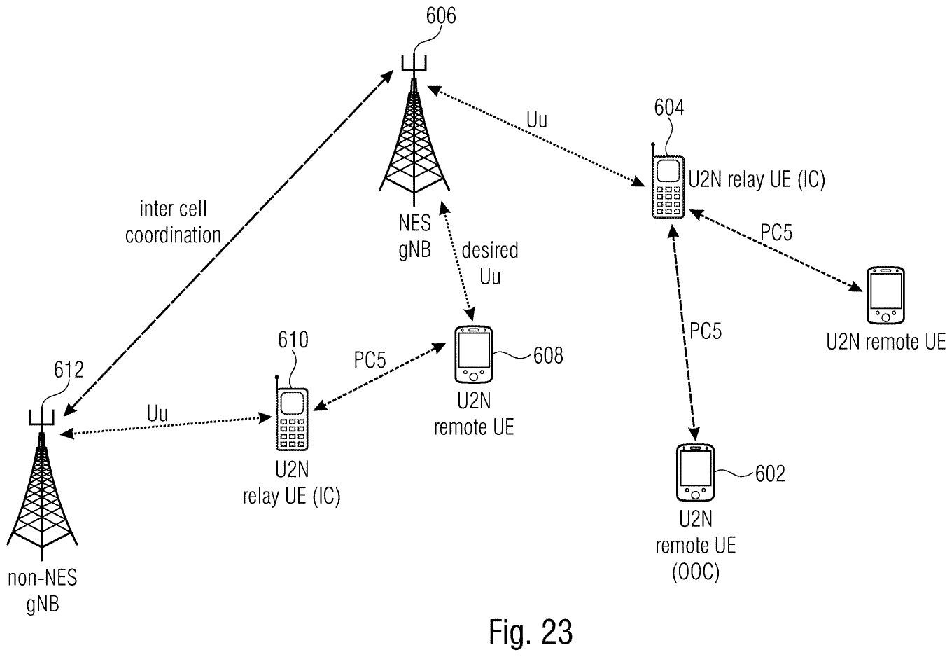

FIG. 23 shows a schematic representation of an exemplary sidelink relaying scenario. As shown in FIG. 23, an out of coverage (OOC) U2N remote UE 602 can communicate over a sidelink (e.g., using the PC5 interface) via a U2N Relay UE 604 with a first gNB 606, where the U2N Relay UE 604 forward information to or from the first gNB 606 using a Uu interface. Moreover, another UE 608 might be connected to both, another U2N Relay UE 610 and directly to the first gNB 606, where the other U2N Relay UE 610 is connected via its Uu interface to a second gNB 612. As indicated in FIG. 23, inter cell coordination might take place between the two gNBs 606 and 612.

### 10. Broadcast Via Sidelink

Like the embodiments in previous section, the information can be also transmitted via sidelink itself. In this case the UEs can store the TP and broadcast it to the other UEs. This information can be send completely using sidelink when the cell is fully shutdown, or it can be partially transmitted by cell and partially through the sidelink. This information can be broadcasted by the UEs until the cell goes back to the normal operation.

As an example, some group of UEs can be selected to broadcast this information while the cell has been partially or fully shutdown.

According to section 12.3 below, the notification of cell stopping to transmit any of common signals can also be broadcasted through the sidelink.

The information of this specific technique to be used in cell even can give the indication to the UEs which are reselecting the mentioned cell.

### 11. Hybrid Approaches

Naturally, the features of the embodiments described above may be combined in further embodiments.

As one example, in an embodiment PBCH/MIB signaling (see sections 2, 3 and 4) may provide early information on cell-barring and existence of SIB-1 on-demand. Then, DCI signaling provides information on early feasibility, such as PLMN hash (see section 1), and scheduling information for a reduced SIB (e.g., SIB0). Finally SIB-0 provides the information for sending up an uplink request to trigger (full) SIB-1 on-demand, as described in section 5.

In embodiments, cell barring information needs to be available very early in order to prevent UEs from trying to connect to the network via RA procedure. While the UAC information is optional in the SIB-1, it could be part of SIB-0 either fully or as a reduced/compressed version to include a minimum set of information for the UE.

In embodiments, SIB-1 includes optional UAC parameters that can be bound to a PLMN. This information can be used to acquire the PLMN for the wake-up signal. Thereby, in the below example, elements in accordance with embodiments are underlined:

| | |
|---|---|
| UAC-BarringPerPLMN-List ::= | SEQUENCE (SIZE (1.. maxPLMN)) OF UAC-BarringPerPLMN |
| UAC-BarringPerPLMN ::= | SEQUENCE { |
| plmn-IdentityIndex | INTEGER (1..maxPLMN), |
| uac-ACBarringListType | CHOICE{ |
| uac-ImplicitACBarringList | SEQUENCE (SIZE(maxAccessCat-1)) OF UAC- |

BarringInfoSetIndex,

| | |
|---|---|
| uac-ExplicitACBarringList | UAC-BarringPerCatList |

}
OPTIONAL -- Need S
}

### 12. TP Information Provision Before Network Adaptation or UE Timeout

In embodiments, the network may decide to stop regular SSB and/or SIB-1 transmission even when some UEs are still connected. In this case these connected UEs may receive TP information as dedicated signaling from the network, so that UEs which were already on that cell may perform a TP on that cell and remain camping. This may involve a change of UE state to RRC_INACTIVE or RRC_IDLE. If only those UEs can do TP, it is possible that TP is not broadcast but just sent via the dedicated signaling.

In some embodiments, TP information is sent when the network suspends the RRC connection (moving from RRC_CONNECTED to RRC_INACTIVE). Namely, TP information may be included in suspendConfig (TR 38.331). In this case, if the UE needs to come back to RRC_CONNECTED (new traffic) the UE needs to perform a TP before being able to resume the RRC connection.

### 12.1 UE Notification Before Cell Switching to “On-Demand SIB (e.g., SIB1) Configuration”

Any cell broadcasting the full system information (e.g., SSB/MIB & SIB) may change for energy saving reason to a cell transmitting SSB/MIB only. I.e. SIB (e.g., SIB1) will no longer be transmitted by cell periodically, but will only be transmitted on demand.

In embodiments, whenever a cell switches from “full broadcasting mode” (i.e. sending periodically SSB/MIB and SIB-1) to “SIB1 on-demand mode” due to any condition (see next paragraph), one of the following options for sending a notification by the cell to the UEs (e.g., to notify the UEs of the changed cell configuration) may apply:
The switch to “on-demand SIB1” cell may only apply at the point of time, when a “regular” SSB/MIB is sent including the indication, when the UEs are allowed to send a “demand SIB1 notification” to cell, e.g., using
   pdcch-ConfigSlB or any other existing or new (additional) MIB parameter providing information of the uplink configuration/positioning for the UE to be used to send a demand for SIB (e.g., SUB1) transmission to the cell, and/or
   pdcch-ConfigSlB of the MIB, splitting or extending the currently 8 bits including the uplink configuration/positioning for the UE to be used to send a demand for SIB (e.g., SIB1) transmission to cell.
The switch to “on-demand SIB1” cell may be indicated in any SIB (e.g., the last regular, periodically sent SIB1). Optionally, the same SIB (e.g., SIB1) may provide information of the uplink configuration/positioning for the UEs to send a demand for SIB (e.g., SIB1) transmission to the cell.
A timer or countdown indicate to the UEs that the change is about to be made.

### 12.2 Conditions for Cells to Switch to a “On-Demand SIB Configuration”

In embodiments, the conditions why a cell may switch from full SSB/MIB/SIB periodical broadcasting to only SSB/MIB periodical broadcasting with SIB on demand broadcasting may be:
Load based conditions, e.g., whenever the load in the cell falls below a defined threshold, the cell may switch to “on-demand SIB (e.g., SIB1) configuration”.
   Optionally this may only apply for secondary cells.
RRC state of UEs: in case there is no UE in connected RRC state within the given cell (e.g., UEs in idle or idle and inactive RRC state only), the cell may switch to “on-demand SIB (e.g., SIB1) configuration” in case of
   the last UE in RRC connected state on the given cell changed to RRC idle or RRC inactive state, the cell starts an internal procedure to change to “on-demand SIB (e.g., SIB1) configuration”, and/or
   after the last UE in RRC connected state of a given cell changed to RRC idle mode, the cell waits for a defined given time period (e.g., timer based). After a timer expires the cell starts an internal procedure to change to “on-demand SIB (e.g., SIB1) configuration”.

Note: both options may only apply for secondary cells
on demand of the primary cell, the secondary cell may change to “on-demand SIB (e.g., SIB1) configuration”.

### 13. Trigger Procedure Options

In the scope of this invention a TP (Trigger Procedure) is a way at which a network element can trigger a change so that MSI can be sent on-demand. In many cases, this network element may be a UE. For example a TP may be:
Cell Wake-up signal on the same band/cell
Cell Wake-up signal on the another band/cell
Cell Wake-up signal on LTE cell
Cell Wake-up signal via sidelink relay
Trigger message via core

However, it is also possible that the network/gNB uses the same change between broadcasting TP-info or MSI without UE involvement. This may be done e.g.:
On schedule
Via Xn signaling
Via O&M
Via core signaling

### 14. Further Detailed Embodiments

In this section, further details are described of how several aspects already discussed may be combined into detailed embodiments. This is merely illustrative and the combination of elements here is neither limiting nor a minimal set of elements. Instead, it is intended to exemplify how a detailed embodiment may look like.

For simplicity, in this section a TP-Info which is a reduced version of SIB-1, containing information elements similar to SIB-1 (potentially renamed). As described in section 7, this may only contain the fields needed to start the Trigger Procedure (TP). This may include for example, ssb_PositionsInBurst, basic uplink configuration (e.g., based on SIB-1 frequencyInfoUL), RACH information (e.g., based on SIB-1 rach_ConfigCommon), power information (e.g., based on ss_PBCH_BlockPower), TDD configuration (e.g., for TDD bands, based on tdd_UL_DL_ConfigurationCommon) and information to monitor SIB-1 (e.g., based on MIB/SIB-1 pdcch_ConfigCommon). Additionally, the TP-Info may contain the equivalent of SIB-1 cellAccessRelatedInfo, to allow fast identification of which operator the cell belongs to. All this information is significantly sized but still much smaller than a fully-fledged SIB-1.

As described in the previous section, a TP may be, e.g., a “Cell Wake-up signal on the same band/cell” or “Cell Wake-up signal on another band/cell”. Naturally, the first case refers to a case where TP-Info is sent on the same band or cell where the TP is performed, whereas the second case refers to a case where TP-Info is sent on a different band or a different cell other than the one where the TP is performed. For simplicity, the two cases are separate, but they may share the same TP-Info basis described above, as well as the same trigger procedure on the target cell applying on-demand SIB-1. And they even can be combined on the same deployment, in a complementary way. For example, a UE may receive TP-Info in one cell and request SIB-1 in another cell in order to camp on that cell. Later, as the UE needs to update SIB-1 and is already camped on the cell applying on-demand SIB-1 it can obtain TP-Info directly from the target cell. So, in this example in different points of time and different procedures the UE may obtain TP-Info in another cell or directly in the target cell where it sends C-WUS. Or simply, during initial cell selection the UE can obtain TP-Info in either cell (target cell or another cell), in order to speed up the procedure.

14.1 TP-Info Sent on Another Band/Cell (Different from where TP is Executed)

This may be an advantageous embodiment when a gNB manages multiple cells on different bands and on some bands SIB-1 and other SIBs are broadcast regularly whereas other bands apply on-demand SIB-1.

In this embodiment, in reference to the general procedure, the additional steps to obtain TP-Info are performed in one cell whereas the TP and on-demand steps are performed on the target cell.

The bands which broadcast SI may send TP-Info for multiple cells. This is the case for example when a macro-cell sends TP-Info for multiple small cells or when one band needs to send TP-Info related to multiple bands. In these cases, the TP-Info may be tagged by identification of the cell such as the PCI and frequency (e.g., ARFCN). As an example, then TP-Info may contain one or more out of:
PCI,
ARFCN,
ssb_PositionsInBurst,
basic uplink configuration (e.g., based on SIB-1 frequencyInfoUL),
RACH information (e.g., based on SIB-1 rach_ConfigCommon),
power information (e.g., based on ss_PBCH_BlockPower),
TDD configuration (e.g., for TDD bands, based on tdd_UL_DL_ConfigurationCommon),
information to monitor SIB-1 (e.g. based on MIB/SIB-1 pdcch_ConfigCommon).

As some bands are broadcasting SI regularly, TP-Info (e.g., for other cells) can be put into a container such as a new SIB which contains TP-Info for each of other cells. This new SIB may be sent via regular SI schedule or using the other SI mechanism. Alternatively, the TP-Info for other cells may be included in existing SIBs, such as SIB-1, SIB-3 or SIB-4.

14.2 TP-Info Sent on Same Band/Cell where TP is Executed

In this embodiment, a reduced SIB-1 version is sent directly in the target band (e.g., as in described in section 7). Special values of K_ssb, for example, K_ssb=30 for FR1 and K_ssb=14 for FR2, can indicate that the cell is currently not broadcasting SIB-1 but it can broadcast SIB-1 on-demand (e.g., as described in section 3). The CORESET #0 can be monitored by the UE for SI-RNTI, and DCI_1_0 can be extended to have a value which schedules the TP-Info (e.g., pre-SIB-1 or SIB-0 values). However, the UE may consider that pdcch_ConfigSIB1 may be changed when the cell is on status of sending TP-Info (currently applying on-demand SIB-1) as identified by the special values of k_ssb as compared to the status where the cell is currently broadcasting SIB-1. These two status may be identified by a change in k_ssb value, from the special value to a regular value and vice-versa. Using two different k_ssb values in these two different states allow the network to change between an energy efficient multiplexing pattern (see sections 1.2 and 7.1) which may not be able to carry many octets to a regular multiplexing pattern which is inefficient from energy perspective but allows to carry the larger payload of a complete SIB-1.

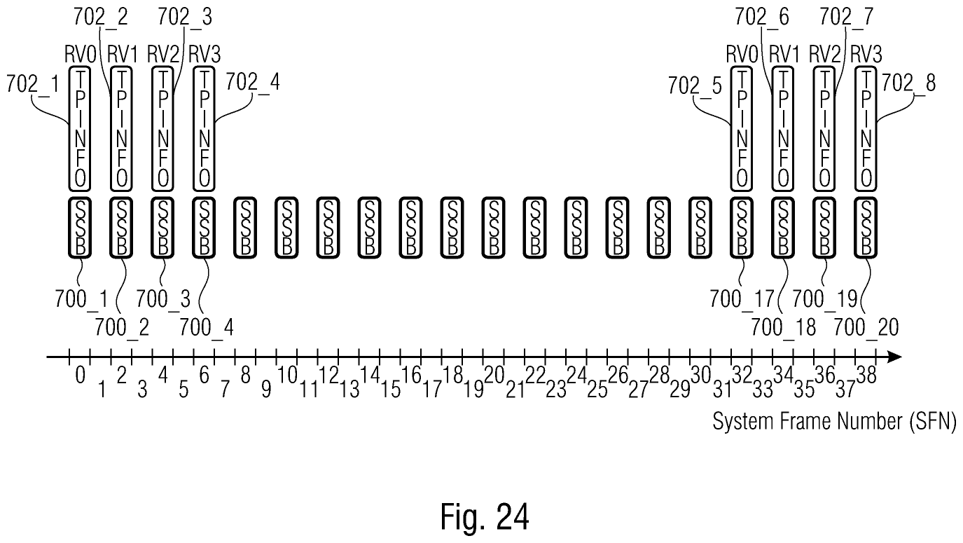

The monitoring pattern of TP-Info in CORESET #0 may be sparser and more optimized than the SIB-1 monitoring. For example, in a cycle of 160 ms TP-Info may be sent with an interval of 20 ms, four times in a row, each with a different Redundancy Version (RV), and then not sent anymore until the next cycle of 160 ms. The UE may be aware of this pattern and optimize reception and its own power consumption accordingly. This can be implemented for example by a fixed pattern for a given SSB periodicity. For example, for SSB periodicity of 20 ms the UE may search only Frames which contain SSBs and satisfy (SFN/8) mod 2=0. That would allow the UE to search for TP-Info in the first four SSB periods but not on the last four ones. For a SSB periodicity of 10 ms, four receptions of TP-Info in parallel to SSB could be done faster. Then the rule can be all system frames which satisfy SFN mod 16 matching 0,1,2,3. In this way the UE may search for TP-Info for four frames and then sleep for twelve frames. If the cycle for sending WUS configuration is different than the SIB-1 cycle (e.g., of 160 ms), these rules can be adjusted accordingly. For example, if the WUS configuration cycle is 320 ms and SSBs are sent every 20 ms, the pattern to send WUS configuration can be the frames satisfying SFN/2 mod 16 matching 0, 1, 2, 3 and for the sake of efficiency transmitting only on SSB frames with an efficient multiplexing pattern (see sections 1.2 and 7.1). This pattern example is shown on FIG. 24. Naturally, the same concept applies with an offset, e.g., (SFN/2+offset) mod 16 matching 0, 1, 2, 3.

Specifically, FIG. 24 shows a schematic representation of a transmission of a first part 700_1 to 700_20 of the access information and of trigger information 702_1 to 702_8 enabling a UE to trigger a transmission of a second part of the access information. Thereby, in FIG. 24 it is exemplarily assumed that the first part 700_1 to 700_20 of the access information are respective SSBs. In other words, FIG. 24 shows an example of efficient sparse pattern for TP-Info, only on frames which also contain SSBs. Different Redundancy versions may be used for each transmission.

Monitoring of paging channels, e.g., using P-RNTI, may be done both in the regular CORESET #0 pattern when the cell is regularly broadcasting SIB-1 as well as the CORESET pattern when TP-Info is broadcasted.

In embodiments, the DCI_1_0 may also be extended to contain a PLMN hash (e.g., as described in other sections) or cellAccessRelatedInfo. Furthermore, DCI_1_0 may include some new information on SIB-1 validity. For example, this may be a validity, version, or value tag. For example, if this SIB-1 version field has 2 bits and the UE has stores SIB-1 with version 01, then the UE needs to monitor this field periodically. If the version is different than the current value stored by the UE (10 or 11) the UE needs to obtain SIB-1 again.

### 14.3 Further Details

Embodiments described herein provide high energy savings while attaining initial access performance. A large degree of backward compatibility possible.

Embodiments described herein can be applied for network energy savings in wireless networks.

Embodiments described herein address/solve the problem of that SSB and SIB-1 are transmitted on all carriers and in each carrier on multiple directions leading to excessive energy consumption without traffic.

Embodiments described herein address/solve the problem of that SSB on-demand and SIB-1 on-demand showed high potential on [3], but it is not described how it can be practically implemented.

Embodiments described herein provide a generic approach for on-demand information. In embodiments. Note that information could be broken down in other steps, not just SSB on-demand and SIB-1 on-demand.

Embodiments described herein provide very detailed design of signaling for each embodiment.

Embodiments described herein provide efficient multiplexing patterns for NES/beam sweeping.

Embodiments described herein provide a practical solution to SIB-1 on-demand Embodiments described herein provide a superior alternative to SIB-1 on-demand as described on [3].

Various elements and features of the present invention may be implemented in hardware using analog and/or digital circuits, in software, through the execution of instructions by one or more general purpose or special-purpose processors, or as a combination of hardware and software.

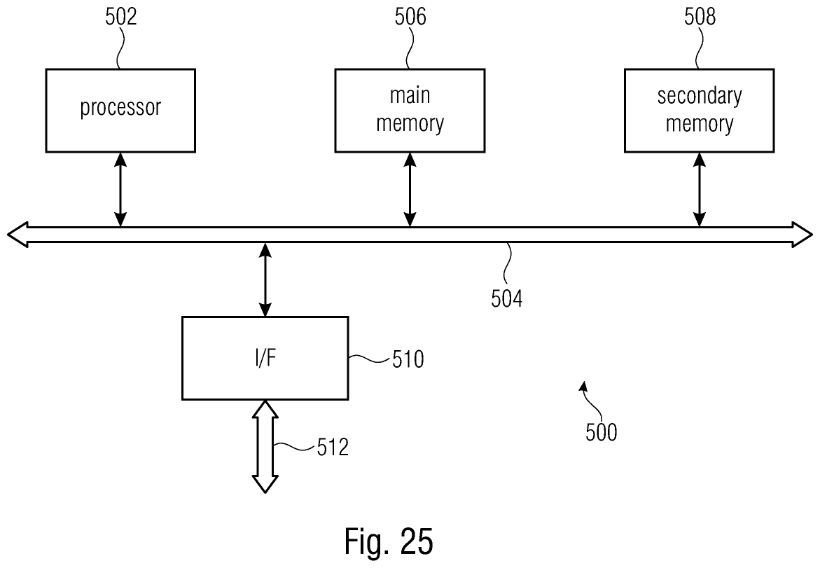

For example, embodiments of the present invention may be implemented in the environment of a computer system or another processing system. FIG. 25 illustrates an example of a computer system 500. The units or modules as well as the steps of the methods performed by these units may execute on one or more computer systems 500. The computer system 500 includes one or more processors 502, like a special purpose or a general-purpose digital signal processor. The processor 502 is connected to a communication infrastructure 504, like a bus or a network. The computer system 500 includes a main memory 506, e.g., a random-access memory (RAM), and a secondary memory 508, e.g., a hard disk drive and/or a removable storage drive. The secondary memory 508 may allow computer programs or other instructions to be loaded into the computer system 500. The computer system 500 may further include a communications interface 510 to allow software and data to be transferred between computer system 500 and external devices. The communication may be in the from electronic, electromagnetic, optical, or other signals capable of being handled by a communications interface. The communication may use a wire or a cable, fiber optics, a phone line, a cellular phone link, an RF link and other communications channels 512.

The terms “computer program medium” and “computer readable medium” are used to generally refer to tangible storage media such as removable storage units or a hard disk installed in a hard disk drive. These computer program products are means for providing software to the computer system 500. The computer programs, also referred to as computer control logic, are stored in main memory 506 and/or secondary memory 508. Computer programs may also be received via the communications interface 510. The computer program, when executed, enables the computer system 500 to implement the present invention. In particular, the computer program, when executed, enables processor 502 to implement the processes of the present invention, such as any of the methods described herein. Accordingly, such a computer program may represent a controller of the computer system 500. Where the disclosure is implemented using software, the software may be stored in a computer program product and loaded into computer system 500 using a removable storage drive, an interface, like communications interface 510.

The implementation in hardware or in software may be performed using a digital storage medium, for example cloud storage, a floppy disk, a DVD, a Blue-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention may be implemented as a computer program product with a program code, the program code being operative for performing one of the methods when the computer program product runs on a computer. The program code may for example be stored on a machine-readable carrier.

Other embodiments comprise the computer program for performing one of the methods described herein, stored on a machine-readable carrier. In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. A further embodiment of the inventive method is, therefore, a data stream or a sequence of signals representing the computer program for performing one of the methods described herein. The data stream or the sequence of signals may for example be configured to be transferred via a data communication connection, for example via the Internet. A further embodiment comprises a processing means, for example a computer, or a programmable logic device, configured to or adapted to perform one of the methods described herein. A further embodiment comprises a computer having installed thereon the computer program for performing one of the methods described herein.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are performed by any hardware apparatus.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

### LIST OF REFERENCES

[1]TS 38.300 v17.6.0 “NR; NR and NG-RAN Overall description”, September 2023
[2]TS 38.331 v17.6.0 “NR; Radio Resource Control (RRC); Protocol specification”, September 2023
[3]TR 38.864 v18.1.0 “Study on network energy savings for NR”, March 2023
[4]TS 38.213 v17.7.0 “NR; Physical layer procedures for control”, September 2023
[5]TS 38.211 v17.6.0 “NR; Physical channels and modulation”, September 2023
[6]TS 38.212 v17.6.0 “NR; Multiplexing and channel coding”, September 2023

ABBREVIATIONS

| | |
|---|---|
| 3GPP | third generation partnership project |
| ACK | acknowledgement |
| ARFCN | absolute radio frequency channel number |
| BFD | beam failure detection |
| BFR | beam failure recovery |
| BRP | beam forming resource pool |
| BWP | bandwidth part |
| BS | base station |
| CD-SSB | cell-defining synchronization signal block |
| CDM | code division multiplexing |
| CG | configured grant |
| CRI | CSI-RS resource indicator |
| CQI | channel quality information |
| CSI | channel state information |
| CSI-RS | channel state information - reference signal |
| D2D | device-to-device |
| DC | dual conectivity |
| DCI | downlink control information |
| DL | downlink |
| DM-RS | demodulation reference signal |
| DRS | discovery reference signal |
| DRX | discontinues reception |
| DTX | discontinues transmission |
| EARFCN | E-UTRA Absolute Radio Frequency Channel Number |
| eNB | evolved node B |
| FR | frequency range |
| FR1 | frequency range one |
| FR2 | frequency range two |
| gNB | next generation node B |
| GSCN | global synchronization channel number |
| HARQ | hybrid automatic repeat request |
| IC | in-coverage - within the coverage of another transceiver |
| ID | identity |
| IFFT | inverse fast Fourier transform |
| IoT | internet of things |
| OOC | out-of-coverage - out of the coverage of another transceiver, |
| | i.e. out of the coverage area of a base station |
| LTE | long-term evolution |
| MAC | medium access control |
| MAC-CE | medium access control - control element |
| MCC | mobile country code |
| MCG | master cell group |
| MIB | master information block |
| MNC | mobile network code |
| MSI | minimum system information |
| NACK | negative acknowledgement |
| NCD-SSB | non cell-defining synchronization signal block |
| NES | network energy savings |
| NPN | non-public network |
| NR | new radio |
| NTN | Non Terrestrial Network |
| OFDM | orthogonal frequency-division multiplexing |
| OFDMA | orthogonal frequency-division multiple access |
| PBCH | physical broadcast channel |
| PC | partial-coverage - one transceiver is in-coverage, another |
| | one is out-of-coverage |
| PC5 | interface using the sidelink channel for D2D communication |
| PDCCH | physical downlink control channel |
| PDSCH | physical downlink shared channel |
| PLMN | public land mobile network |
| PMI | precoding matrix indicator |
| PRACH | physical random access channel |
| PRS | positioning reference signal |
| PSBCH | physical sidelink broadcast channel |
| PSCCH | physical sidelink control channel |
| PSFCH | physical sidelink feedback channel |
| PSS | primary synchronization signal |
| PSSCH | physical sidelink shared channel |
| PUCCH | physical uplink control channel |
| PUSCH | physical uplink shared channel |
| QCL | quasi - colocation |
| RACH | random access channel |
| RAN | radio access networks |
| RB | resource block |
| RE | resource element |
| RedCap | reduced capability |
| RMSI | remaining minimum system infrormation |
| RNTI | radio network temporary identifier |
| RRC | radio resource control |
| RS | reference signal |
| RSRP | reference signal received power |
| RSRQ | reference signal received quality |
| SCI | sidelink control information |
| SCG | secondary cell group |
| SCS | subcarrier spacing |
| SI | system information |
| SIB | system information block |
| SL | sidelink |
| SNPN | stand-alone non-public network |
| SPS | semi persistent scheduling |
| SR | scheduling request |
| SRS | sounding reference signal |
| SSB | synchronization signal block |
| SSS | secondary synchronization signal |
| S-SSB | sidelink synchronization signal block |
| sTTI | short transmission time interval |
| SUL | supplementary uplink |
| TDD | time division duplex |
| TP | trigger procedure |
| TRS | tracking reference signal |
| UAC | unified access control |
| UE | user equipment, e.g., a smartphone or IoT node |
| UL | uplink |
| UMTS | universal mobile telecommunication system |
| V2X | vehicle-to-everything |
| V2V | vehicle-to-vehicle |
| x-MSI | cross-carrier minimum system information |

1. Base station for a wireless communication network,
wherein the base station is configured to serve a cell of the wireless communication network,
wherein the base station is configured to transmit access information enabling one or more user equipments to access the cell,
wherein the base station is configured, in an energy saving mode of operation, to transmit the access information by transmitting
a first part of the access information, and
a trigger information enabling a user equipment of the one or more user equipments to trigger a transmission of a second part of the access information,
wherein the base station is configured to serve a plurality of cells or bands,
wherein the base station is configured to transmit the first part of the access information and the trigger information on a first cell or band,
wherein the base station is configured to receive a trigger signal and to transmit the second part of the access information in response to the trigger signal on a second cell or band, different from the first cell or band.

2. Base station according to claim 1,
wherein the base station is configured, in the energy saving mode of operation, to transmit the access information by transmitting
the second part of the access information in response to a reception of the trigger signal.

3. Base station according to claim 1,
wherein the first part of the access information and the second part of the access information from the access information.

4. Base station according to claim 1,
wherein the access information comprises synchronization signals and/or system information.

5. Base station according to claim 4,
wherein the first part of the access information comprises only a first part of the synchronization signals and/or system information,
wherein the second part of the access information comprises at least a second part of the synchronization signals and/or system information.

6. Base station according to claim 4,
wherein the access information comprises at least two out of
a primary synchronization signal,
a secondary synchronization signal,
a master information block, MIB,
a system information block one, SIB-1,
a further system information block.

7. Base station according to claim 1,
wherein the base station is configured, in a normal operation mode, to transmit the access information by transmitting the first part of the access information and the second part of the access information.

8. Base station according to claim 1,
wherein the first part of the access information indicates whether the trigger information is transmitted.

9. Base station according to claim 1,
wherein the base station is configured to transmit a first signaling information indicating whether and/or when the trigger information and/or the second part of the access information are transmitted.

10. Base station according to claim 1,
wherein the base station is configured to transmit a second signaling information indicating whether and/or when the base station will switch between the energy saving operation mode and a normal operation mode.

11. Base station according to claim 1,
wherein the base station is configured, in the energy saving mode of operation, to only receive random access signals that carry the trigger signal.

12. Base station according to claim 1,
wherein the base station is configured to transmit the trigger information using beamforming in a plurality of beamforming directions.

13. Base station according to claim 1,
wherein the trigger signal is a wake-up signal transmitted on the same cell than the access information, wherein the trigger information describes a time and/or frequency resource to be used for transmitting the trigger signal,
or wherein the trigger signal is a wake-up signal transmitted on another cell than the access information, wherein the trigger information describes how to access the other cell for transmitting the trigger signal,
or wherein the trigger signal is transmitted on a LTE cell, wherein the trigger information describes a frequency of the LTE cell for transmitting the trigger signal,
or wherein the trigger signal is transmitted via a sidelink, wherein the trigger information describes a sidelink resource pool for transmitting the trigger signal.

14. Base station according to claim 1,
wherein the second part of the access information comprises a system information block one, SIB-1.

15. Base station according to claim 14,
wherein the base station is configured to transmit an additional information comprising the trigger information and a portion of the system information block one, SIB-1.

16. Base station according to claim 1,
wherein the first part of the access information comprises a master information block, MIB,
wherein the second part of the access information comprises a system information block one, SIB-1,
wherein the trigger information is comprised in the master information block, MIB,
wherein the trigger information is comprised in the master information block, MIB, by means of a direct indication that the transmission of the second part of the access information is to be triggered by the trigger signal,
wherein the trigger signal is a wake-up signal.

17. Base station according to claim 1,
wherein the first part of the access information comprises a master information block, MIB,
wherein the second part of the access information comprises a system information block one, SIB-1,
wherein the base station is configured to transmit an additional information comprising a partial system information block one comprising only a part of the system information block one,
wherein the partial system information block one comprises the trigger information,
wherein the base station is configured to transmit the partial system information block one using beamforming in a plurality of beamforming directions.

18. Base station according to claim 1,
wherein the base station is configured to control a user equipment of the cell to transmit the trigger information in case that the base station switches to an energy saving operation mode.

19. Base station according to claim 1,
wherein the base station is configured to switch into the energy saving mode of operation in dependence on an operation condition.

20. Base station according to claim 19,
wherein the operation condition is at least one out of
a load of the base station,
a radio resource control state of user equipments connected to the base station,
a reception of a control signal controlling the base station to the energy saving mode of operation.

21. Base station according to claim 1,
wherein the base station is configured to switch between a normal operation mode and the energy saving operation mode in dependence on at least one out of
scheduling,
Xn signaling,
O&M,
core signaling.

22. Base station according to claim 1,
wherein the trigger information describes one or more out of
a position of a synchronization signal,
at least a part of an uplink configuration,
at least a part of a random access channel configuration,
at least a part of a power configuration,
at least a part of a time and/or frequency division duplex configuration,
at least a part of a system information configuration.

23. Base station according to claim 1,
wherein the base station is configured to receive the trigger signal on the first cell or band,
wherein the base station is configured to transmit at least one out of
the first part of the access information,
the trigger information,
the second part of the access information,
on the second cell or band, different from the first band or cell.

24. Base station according to claim 1,
wherein the trigger information enables the user equipment to trigger the transmission of the second part of the access information in at least one second cell.

25. Base station according to claim 24,
wherein the trigger information describes, for each of the at least one second cell, one or more out of
an identity of the second cell,
a frequency or channel of the second cell,
a position of a synchronization signal,
at least a part of an uplink configuration,
at least a part of a random access channel configuration,
at least a part of a power configuration,
at least a part of a time and/or frequency division duplex configuration,
at least a part of a system information configuration.

26. Base station according to claim 25,
wherein the base station is configured to transmit the trigger information by means of a container,
or wherein the base station is configured to transmit the trigger information together with system information of the first cell or band.

27. User equipment, UE, for a wireless communication network,
wherein the user equipment is configured to access a cell that is in an energy saving mode of operation and that is transmitting in the energy saving mode of operation only a first part of access information required by the user equipment for accessing the cell,
wherein the user equipment is configured to access the cell by at least one out of
receiving the first part of the access information,
receiving a trigger information enabling the user equipment to trigger a transmission of a second part of the access information, and
transmitting a trigger signal based on the trigger information,
wherein the user equipment is configured to receive the first part of the access information and the trigger information on a first cell or band,
wherein the user equipment is configured to transmit the trigger signal and to receive the second part of the access information on a second cell or band, different from the first cell or band.

28. User equipment according to claim 27,
wherein the user equipment is configured to access the cell by
receiving the second part of the access information.

29. User equipment according to claim 27,
wherein the first part of the access information and the second part of the access information from the access information.

30. User equipment according to claim 27,
wherein the access information comprises synchronization signals and/or system information.

31. User equipment according to claim 30,
wherein the first part of the access information comprises only a first part of the synchronization signals and/or the system information,
wherein the second part of the access information comprises at least a second part of the synchronization signals and/or the system information.

32. User equipment according to claim 30,
wherein the access information comprises at least two out of
a primary synchronization signal,
a secondary synchronization signal,
a master information block, MIB,
a system information block one, SIB-1,
a further system information block.

33. User equipment according to claim 27,
wherein the first part of the access information indicates whether the trigger information is transmitted.

34. User equipment according to claim 27,
wherein the user equipment is configured to receive a first signaling information indicating whether and/or when the trigger information and/or the second part of the access information are transmitted.

35. User equipment according to claim 27,
wherein the user equipment is configured to receive a second signaling information indicating whether and/or when a base station will switch between an energy saving operation mode and a normal operation mode.

36. User equipment according to claim 27,
wherein the user equipment is configured to receive the trigger information by receiving one out of a plurality of different beams by means of which the trigger information is transmitted.

37. User equipment according to claim 27,
wherein the trigger signal is wake-up signal transmitted on the same cell than the access information, wherein the trigger information describes a time and/or frequency resource to be used for transmitting the trigger signal,
or wherein the trigger signal is wake-up signal transmitted on another cell than the access information, wherein the trigger information describes how to access the other cell for transmitting the trigger signal,
or wherein the trigger signal is transmitted on a LTE cell, wherein the trigger information describes a frequency of the LTE cell for transmitting the trigger signal,
or wherein the trigger signal is transmitted via a sidelink, wherein the trigger information describes a sidelink resource pool for transmitting the trigger signal.

38. User equipment according to claim 27,
wherein the second part of the access information comprises at least a part of a system information block one, SIB-1.

39. User equipment according to claim 38,
wherein the user equipment is configured to receive an additional information comprising the trigger information and a portion of the system information block one, SIB-1.

40. User equipment according to claim 27,
wherein the first part of the access information comprises a master information block, MIB,
wherein the second part of the access information comprises a system information block one, SIB-1,
wherein the trigger information is comprised in the master information block, MIB,
wherein the trigger information is comprised in the master information block, MIB, by means of a direct indication that the transmission of the second part of the access information is to be triggered by the trigger signal,
wherein the trigger signal is a wake-up signal.

41. User equipment according to claim 27,
wherein the first part of the access information comprises a master information block, MIB,
wherein the second part of the access information comprises a system information block one, SIB-1,
wherein user equipment is configured to receive an additional information comprising a partial system information block one, SIB-1, comprising only a part of the system information block one,
wherein the partial system information block one comprises the trigger information,
wherein the user equipment is configured to receive the partial system information block one by receiving a beam of a plurality of different beams using which the partial system information block one is transmitted.

42. User equipment according to claim 27,
wherein the trigger information describes one or more out of
a position of a synchronization signal,
at least a part of an uplink configuration,
at least a part of a random access channel configuration,
at least a part of a power configuration,
at least a part of a time and/or frequency division duplex configuration,
at least a part of a system information configuration.

43. User equipment according to claim 27,
wherein the user equipment is configured to transmit the trigger signal on the first cell or band,
wherein the user equipment is configured to receive at least one out of
the first part of the access information,
the trigger information,
the second part of the access information,
on the second cell or band, different from the first band or cell.

44. User equipment according to claim 27,
wherein the trigger information enables the user equipment to trigger the transmission of the second part of the access information in at least one second cell.

45. User equipment according to claim 44,
wherein the trigger information describes, for each of the at least one second cell, one or more out of
an identity of the second cell,
a frequency or channel of the second cell,
a position of a synchronization signal,
at least a part of an uplink configuration,
at least a part of a random access channel configuration,
at least a part of a power configuration,
at least a part of a time and/or frequency division duplex configuration,
at least a part of a system information configuration.

46. User equipment according to claim 45,
wherein the user equipment is configured to receive the trigger information by means of a container,
or wherein the user equipment is configured to receive the trigger information together with system information of the first cell or band.

47. Method for operating a base station for a wireless communication network, the method comprising:
serving a cell of the wireless communication network,
transmitting access information enabling one or more user equipments to access the cell,
wherein in an energy saving mode of operation the access information is transmitted by transmitting
a first part of the access information, and
a trigger information enabling a user equipment of the one or more user equipments to trigger a transmission of a second part of the access information,
wherein serving comprises serving a plurality of cells or bands,
wherein the first part of the access information and the trigger information are transmitted on a first cell or band,
wherein the method comprises receiving a trigger signal,
wherein the second part of the access information is transmitted in response to the trigger signal on a second cell or band, different from the first cell or band.

48. Method for operating a user equipment, UE, for a wireless communication network, the method comprising:
accessing a cell that is in an energy saving mode of operation and that is transmitting in the energy saving mode of operation only a first part of access information required by the user equipment for accessing the cell,
wherein accessing the cell comprises
receiving the first part of the access information,
receiving a trigger information enabling the user equipment to trigger a transmission of a second part of the access information, and
transmitting a trigger signal based on the trigger information,
wherein the first part of the access information and the trigger information are received on a first cell or band,
wherein the trigger signal is transmitted and the second part of the access information are received on a second cell or band, different from the first cell or band.

49. A non-transitory digital storage medium having a computer program stored thereon to perform the method of claim 47 when said computer program is run by a computer.

50. A non-transitory digital storage medium having a computer program stored thereon to perform the method of claim 48 when said computer program is run by a computer.
